(19) United States
(12) Patent Application Publication
(10) Pub. No.: US 2006/0233346 A1
(43) Pub. Date: Oct. 19, 2006

(54) Method and system for prioritizing performance interventions

(75) Inventors: John C.C. McIlwaine, Alpharetta, GA (US); Scott Richter, Gainesville, GA (US); Kirt W. Pulaski, Suwanee, GA (US); Susan Harman, (US); Dianna Spence, Cumming, GA (US); Solomon Shaffer, Alpharetta, GA (US)

Correspondence Address: KING & SPALDING LLP, 1180 PEACHTREE STREET, ATLANTA, GA, 30309, US

(73) Assignee: Knowlagent, Inc., Alpharetta, GA (US)

(21) Appl. No.: 11/291,533

(22) Filed: Dec. 1, 2005

Related U.S. Application Data
(63) Continuation-in-part of application No. 10/733,137, filed on Dec. 11, 2003.
Application No. 10/733,137 is a continuation-in-part of application No. 10/602,804, filed on Jun. 24, 2003.
Application No. 10/602,804 is a continuation of application No. 09/442,207, filed on Nov. 16, 1999, now Pat. No. 6,628,777.

(51) Int. Cl. H04M 3/00

(52) U.S. Cl. 379/265.02

(57) ABSTRACT

A member of a workforce of a contact center, such as an agent of a call center, can receive performance interventions, such as training, information, tips, or other items intended to enhance workplace performance. The performance interventions can be organized, sequenced, ranked, or prioritized in a lineup, an ordered list, or a queue, that specifies the sequence that the workforce member should receive the performance interventions. The agent might select a training course at the top of the list, for example. Two criteria, parameters, or values can characterize some aspect of each performance intervention. One criterion might characterize time sensitivity, while the other criterion might characterize importance, for example. Processing the two parameters can determine the sequence of performance intervention delivery.

### CROSS REFERENCE TO RELATED APPLICATIONS

This application is a continuation in part of and claims priority to U.S. patent application Ser. No. 10/733,137, entitled “Managing the Selection of Performance Interventions in a Contact Center” and filed Dec. 11, 2003, which is a continuation in part of and claims priority to U.S. patent application Ser. No. 10/602,804, entitled “Method and System for Scheduled Delivery of Training to Call Center Agents” and filed Jun. 24, 2003, which is a continuation of U.S. patent application Ser. No. 09/442,207, now U.S. Pat. No. 6,628,777, entitled “Method and System for Scheduled Delivery of Training to Call Center Agents” and issued Sep. 30, 2003. The entire contents of each of the above listed priority documents are hereby incorporated by reference.

### TECHNICAL FIELD

The present invention relates generally to enhancing performance of a contact center workforce, such as an agent of a call center, and more specifically to prioritizing or sequencing the delivery of performance interventions, such as training courses, to members of the workforce.

### BACKGROUND OF THE INVENTION

A contact center, such as a call center, is a system in which a staff of agents provides remote service, via a communication network, to contacts that may be customers or other constituents of an organization. The communication network can be the public switched telephone network (“PSTN”), an intranet, a local area network (“LAN”), or the Internet, to name a few examples.

In a call center or a contact center based on telephonic communications, calls are typically distributed and connected to agents that are available at the time of the call or that are otherwise most suited to handle the call. The call distribution function, commonly referred to as automatic call distribution (“ACD”), is generally implemented in software that executes in a switching system, such as a private branch exchange (“PBX”), that connects contact calls to agent telephones. A workforce management (“WFM”) component is often employed by a contact center to schedule and manage agent staffing and contact center capacity.

More recently, computer-telephony integration (“CTI”) has been widely employed in contact centers. In a typical contact center, a CTI component conveys telephony information, such as the telephone number of a calling party and the identity of the agent to whom the call is connected, from the ACD switching system to other components of the contact center system. The other components of the contact center system typically use this information to send relevant database information, such as the account file of the calling party, across a LAN or other communications infrastructure to a data terminal of the agent to whom the call is connected. The CTI component, other system components, and the LAN can also be used to deliver other information to the agents.

More generally, the business function provided by a contact center may be extended to a variety of communications media and to contact with constituents of an organization other than its customers. For example, an e-mail help desk may be employed by an organization to provide technical support to its employees. Web-based “chat”-type systems may be employed to provide information to sales prospects. With the development of broadband communications infrastructure, agents and contacts can communicate with one another via streaming video or other high-bandwidth interactions. Thus, a modern contact center can support various media and forms of communication with a broad range of constituents or contacts.

Agents of contact centers need to be well-trained in order to maximize their productivity and effectiveness. Agent training should be intensive and frequent in contact centers that handle complex interactions with constituents or that change call scripts or other interaction programs often. In many situations, the quality and effectiveness of agent training may significantly drive the performance of the contact center in terms of achieving its business objectives.

In conventional contact centers, agents may receive training via a variety of mechanisms. A supervisor at the contact center may simply walk over to individual agents for face-to-face interaction, place telephone calls to the individual agents, or otherwise personally pass new information to agents. Information may be distributed by email, by an instructor in a classroom setting, or over an intranet. Alternatively, the information may be broadcast over a public announcement system or may be displayed on large wall displays or “reader boards” at various locations of the contact center. New information may also be provided through a “chair drop” or “huddle” by which written information updates or training materials are handed to the agents for their consumption.

More recently, automated methods for agent training and information updating have been developed. Computer-based training (“CBT”) involves the distribution of training programs to computer-based agent workstations or to a shared workstation dedicated to training. CBT content may be distributed in a broadcast mode, with each agent receiving the same training at the same time. However, CBT may also involve allowing individual agents to access desktop training on their own schedules and at their own paces through self-directed CBT.

In self-directed CBT, each agent takes the initiative to enter a training session, and the pace and content of the training can reflect individual learning rates and base knowledge. While agents may enjoy the flexibility of self-directed CBT, they may conduct conventional CBT training sessions in the interest of their personal convenience rather than in a concerted effort to enhance their effectiveness in helping the contact center achieve its business objectives. Even conscientious agents may need or want guidance in selecting, sequencing, or scheduling training that will enhance their agent skills, and conventional CBT systems often fail to provide a sufficient level of such guidance.

Broadcast CBT systems usually deliver uniform training to all agents regardless of individual agent skill levels. That one-size-fits-all approach often fails to accommodate the significant variations in learning rates or base knowledge that can exist among agents. While self-directed CBT enables agents to learn at their own paces and to select training materials addressing their individual skills shortcomings, conventional self-directed training is usually not amenable to centralized management and control by the contact center. For example, conventional self-directed CBT may depend on the agent's self-evaluation of personal shortcomings. And, conventional CBT systems may not automatically tailor training materials or assignments to agents based on objective evaluations of each agent's skills and performance. As a result, contact centers employing conventional CBT systems and techniques are generally unable to tailor training regimes to the needs of individual agents. Moreover, conventional CBT technologies generally lack a capability to direct agents to take training courses in a preferred sequence. Faced with selecting one course from numerous possibilities, the agent may fail to select a course that could prepare the agent for an upcoming event such as a product launch. Further, the agent may not realize that a specific course contains important content. And, self-directed CBT generally does not support assigning a priority or a deadline to one or more training sessions.

Conventional CBT does not generally provide provisions to specify the training sessions to be delivered, a preferred order for training session delivery, the agents to receive training, and a delivery rate. Further, conventional contact centers usually lack a capability to manage training in a coordinated fashion that promotes the operational effectiveness and performance of the contact center. As a result, contact centers employing conventional techniques for delivering CBT, or other performance interventions, may forego agent training in order to meet short-term performance objectives. Conversely, such contact centers may compromise short-term performance in order to meet long-term training objectives.

In addition to failing to balance short- and long-term objectives, conventional contact centers do not generally deliver performance interventions in a manner that adequately responds to changing conditions, such as fluctuating call volume and contact center performance. More specifically, conventional contact centers generally neither set the number of performance interventions delivered in an increment of time nor select performance interventions in a preferred order or sequence for delivery on the basis of such dynamic conditions.

Rather than respond dynamically to changing conditions in the contact center, contact centers often use conventional schedules to dictate a timeframe for one or more specific agents to receive one or more specific performance interventions. A member of management typically drafts such conventional schedules manually. Often drafted weeks in advance, the schedules are typically fixed and can not easily accommodate the inherent uncertainty and fluid nature of the contact center's operations. Consequently, such static schedules are limited in terms of ability to adapt the selection or sequencing of performance interventions or agents to the dynamic conditions of the contact center.

One conventional approach to selecting performance interventions for delivery to agents in a contact center involves self assignment. The contact center maintains a library of interventions from which each agent selects interventions according to personal preference. The management of the contact center applies each selected intervention against an intervention budget. One drawback to the self assignment of performance interventions is that selections are often skewed towards benefiting a specific agent or satisfying a specific agent's curiosity rather than advancing the contact center's operational effectiveness.

Another conventional approach to managing performance interventions entails a manager assigning performance interventions to an agent during an annual review. The manager may suggest specific performance interventions that he/she would like for the agent to receive. One shortcoming of this approach is that it generally does not include performance intervention prioritization. Furthermore, the approach generally does not accommodate precise delivery deadlines.

To address those representative deficiencies in the art, what is needed is a capability for sequencing, prioritizing, or ranking performance interventions for delivery in a contact center. A further need exists for establishing a delivery sequence based on two or more parameters. Yet another need exists for setting or refining the delivery sequence based on a performance intervention's history of improving agent performance. Such a capability would benefit the agent population and would serve the overall operational effectiveness of the contact center.

### SUMMARY OF THE INVENTION

The present invention supports improving or enhancing the performance, effectiveness, or efficiency of one or more members of the workforce of a contact center, such as the agents of a call center. In one aspect of the present invention, a computer-based method or system can prioritize performance interventions, such as training courses, tips, information presented on a computer monitor, coaching, reprimands, or some other item intended to change performance or provide benefit. Prioritizing performance interventions can comprise determining or specifying a preferred sequence, order, rank, lineup, or prioritization for delivering two or more performance interventions. For example, critical product training needed to support an upcoming product launch might be prioritized for express delivery, ahead of general training that is less time sensitive.

The preferred sequence for delivering or providing the performance interventions can be determined by processing or considering two parameters, values, or criteria for each of the performance interventions. Thus, each of two parameters or values can describe each of the performance interventions. That is, respective values of a first parameter and a second parameter can describe some aspect of each of the performance interventions. For example, a timeframe and a level of importance might be assigned to or computed for each of two or more training courses. As another example, a projected benefit and an urgency might be associated with each of a first course, a second course, and a third course.

Processing two or more parameters or values to determine a preferred sequence for delivering the performance interventions can comprise applying rules to the parameters or values, referencing the parameters or values to a lookup table or a data file, weighing the parameters or values, applying statistics to data associated with the parameters or values, or computing priorities based on the parameters or values, to name a few possibilities. The parameters or values can comprise parametric values, criteria, numbers, categories, classifications, distinguishing characteristics, designations, data, information, measurements, factors, descriptions, statistical data, empirical data, monitored information, or other items that relate to each of the performance interventions. The two parameters or values can be independent, dependent, distinct, unique, mutually exclusive, related, unrelated, or overlapping with respect to one another.

The discussion of prioritizing performance interventions presented in this summary is for illustrative purposes only. Various aspects of the present invention may be more clearly understood and appreciated from a review of the following detailed description of the disclosed embodiments and by reference to the drawings and claims. It is intended that all such aspects be included within this description, be within the scope of the present invention, and be protected by the accompanying claims.

### BRIEF DESCRIPTION OF THE DRAWINGS

FIG. 1 is a block diagram illustrating a system for managing a computer-based customer call center system in accordance with an exemplary embodiment of the present invention.

FIG. 2 is a block diagram illustrating a system for the scheduling and delivery of training materials in accordance with an exemplary embodiment of the present invention.

FIGS. 3A, 3B, and 3C, collectively FIG. 3, are flowcharts indicating the steps in the methods for training a contact agent to perform constituent contact duties in accordance with an exemplary embodiment of the present invention.

FIG. 4 illustrates a functional block diagram of a contact center with an intervention manager according to one exemplary embodiment of the present invention.

FIG. 5A illustrates inputs and outputs of an intervention manager according to one exemplary embodiment of the present invention.

FIG. 5B illustrates functional relationships between primary inputs and primary outputs of an intervention manager according to one exemplary embodiment of the present invention.

FIG. 5C illustrates functional relationships between primary inputs and primary outputs of an intervention manager according to one exemplary embodiment of the present invention in which the rate of intervention delivery is based on intervention parameters and contact center state.

FIGS. 6A and 6B, collectively FIG. 6, graphically illustrate adjusting the number of performance interventions delivered over time based on the state of a contact center according to one exemplary embodiment of the present invention.

FIGS. 7A and 7B, collectively FIG. 7, graphically illustrate forecasting the state of a contact center and managing performance intervention delivery based on the forecast according to one exemplary embodiment of the present invention.

FIG. 8 graphically illustrates adjusting the rate of delivering performance interventions based on the state of the contact center according to one exemplary embodiment of the present invention.

FIG. 9 graphically illustrates selecting performance interventions based on performance intervention priority and contact center state according to one exemplary embodiment of the present invention.

FIG. 10 illustrates a flowchart for a process for managing performance intervention delivery according to one exemplary embodiment of the present invention.

FIG. 11 illustrates a flowchart for a process for adjusting the rate of delivering performance interventions according to one exemplary embodiment of the present invention.

FIG. 12 illustrates a flowchart for a process for selecting performance interventions according to one exemplary embodiment of the present invention.

FIG. 13 illustrates a flowchart for a process for selecting agents to receive performance interventions according to one exemplary embodiment of the present invention.

FIG. 14 illustrates a flowchart for a process for delivering performance interventions to agents according to one exemplary embodiment of the present invention.

FIG. 15 illustrates a flowchart for a process for controlling the delivery of performance interventions to agents according to one exemplary embodiment of the present invention.

FIG. 16 illustrates a module that receives a list of performance interventions and ranks or sequences the performance interventions in a preferred delivery order according to one exemplary embodiment of the present invention.

FIG. 17 illustrates a flowchart of a process for initiating the ranking of performance interventions according to one exemplary embodiment of the present invention.

FIG. 18 illustrates a flowchart of a process for ranking performance interventions according to one exemplary embodiment of the present invention.

FIGS. 19A and 19B, collectively FIG. 19, respectively illustrate a flowchart and example data of a process for assigning a deliver-by priority to a performance intervention according to one exemplary embodiment of the present invention.

FIGS. 20A, B, C, and D, collectively FIG. 20, illustrate a flowchart, sample data, and a matrix operator of a process for computing a priority for performance interventions according to one exemplary embodiment of the present invention.

FIG. 21 illustrates a window of a graphical user interface (“GUI”) for specifying rules for prioritizing performance interventions according to one exemplary embodiment of the present invention.

FIG. 22 illustrates a GUI window for displaying a prioritized list of performance interventions according to one exemplary embodiment of the present invention.

FIG. 23 illustrates a GUI window for displaying information about a performance intervention to an agent of a contact center according to one exemplary embodiment of the present invention.

FIG. 24 illustrates a graph comparing the monitored performances of two contact center agents that result from delivery of a performance intervention to one of the agents according to one exemplary embodiment of the present invention.

FIG. 25 illustrates a flowchart of a process for setting a priority of a performance intervention based on monitoring agent performance following delivery of the performance intervention according to one exemplary embodiment of the present invention.

Many aspects of the invention can be better understood with reference to the above drawings. The components in the drawings are not necessarily to scale, emphasis instead being placed upon clearly illustrating the principles of exemplary embodiments of the present invention. Moreover, in the drawings, reference numerals designate corresponding, but not necessarily identical, parts throughout the different views.

### DETAILED DESCRIPTION OF EXEMPLARY EMBODIMENTS

Exemplary embodiments of the present invention support managing the selection, prioritization, or sequencing of performance interventions for delivery to agents of a contact center or to another member of a contact center's workforce. Performance interventions can be training sessions, courses, tips, information, reprimands, coaching content, warnings, or other items intended to enhance workplace performance or efficiency. A performance intervention could be a communication delivered to an agent with the intent to enhance the performance, proficiency, and/or effectiveness of that agent, for example. The performance interventions can be organized, sequenced, ranked or prioritized in a lineup, an ordered list, or a queue, that specifies, outlines, or describes the sequence that the workforce member should receive the performance interventions. The agent might select a training course from the top of the list, for example. The performance interventions can be sequenced according to a specified priority or importance that is associated with each performance intervention and a specified timeframe or deadline for delivering each performance intervention. A supervisor can designate a course as having a high level of priority, for example. Management might want to provide a course in advance of an upcoming product rollout or a marketing campaign, for example.

Feedback obtained by monitoring agent performance can provide the basis for changing course priority or sequence. Courses that have demonstrated a history of increasing agent performance can receive higher priority or a higher position in the sequence than other courses.

Delivering performance interventions in a preferred sequence can increase the effectiveness, performance, or proficiency of the agent population or provide some other benefit to the contact center's operations. Managing the delivery of performance interventions to agents can include controlling the intervention delivery process to avoid adversely impacting the performance of the contact center during intervention delivery.

A contact center can be a system staffed with agents who service customers or constituents though a communication network. An inbound call center can be one example of a contact center.

One exemplary embodiment of the present invention can manage performance intervention delivery in a contact center by selecting performance interventions for delivery based on the state of the contact center. Contact center state can be one or more factors that describe or affect a contact center's operations. The rate at which the contact center services contacts or receives incoming calls are two examples of contact center state. Contact center state can also be a measurement of the center's performance, such as the average time that a contact waits, e.g. “on hold,” prior to receiving service from an agent. An exemplary embodiment of the present invention can select or sequence performance interventions based on a current or a forecasted state or based on other factors.

Comparing the state of the contact center to a management input, such as a specified level of contact center state, can form the basis for selecting performance interventions. Contact center state meeting a management-input level or another criterion can trigger a computer-based selection process to select performance interventions that have predetermined characteristics. Priority, or importance of delivery, can be one example of a predetermined characteristic. The management-input level can be a desired level of performance for the contact center. The selection process can include rules that preferentially select high-priority performance interventions over low-priority performance interventions when performance of the contact center is lower than the desirable level. At times when contact center performance is above a management-input level, the selection process can choose from a broader range of performance interventions.

A computer program can select agents to receive performance interventions in conjunction with selecting and/or sequencing performance interventions. Agent selection can be based on need. Lower performing agents can preferentially receive selected performance interventions over higher performing agents. Ranking the relative performance of each agent in a group of agents can define a sequence for delivering performance interventions to the group.

The present invention can be embodied in many different forms and should not be construed as limited to the embodiments set forth herein; rather, these embodiments are provided so that this disclosure will be thorough and complete, and will fully convey the scope of the invention to those having ordinary skill in the art. Furthermore, all “examples” given herein are intended to be non-limiting, and among others supported by exemplary embodiments of the present invention.

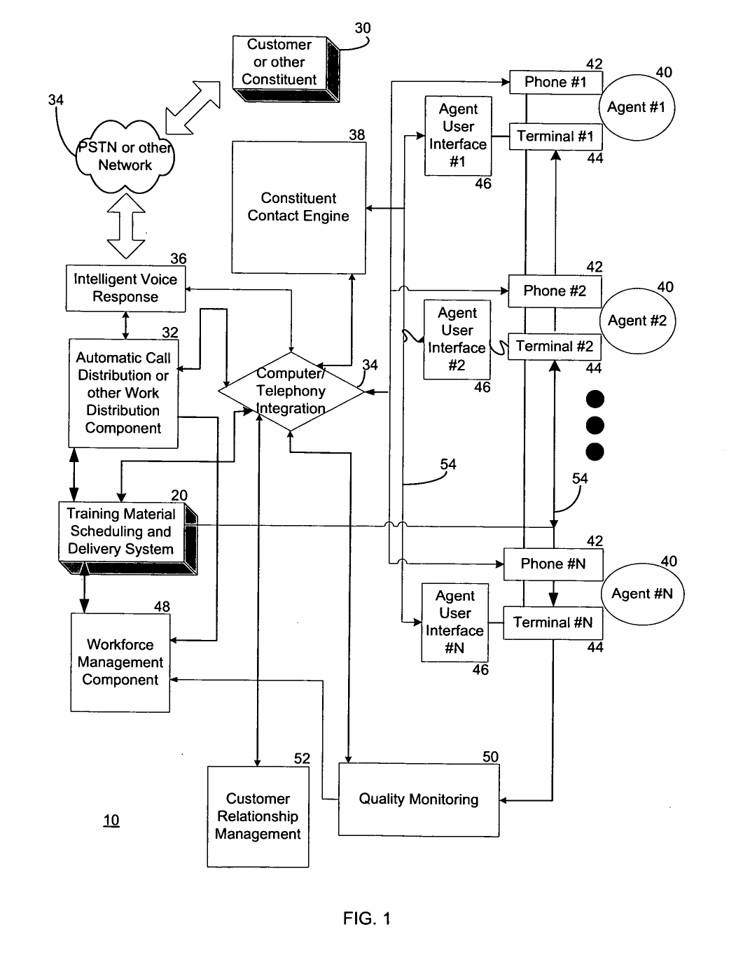

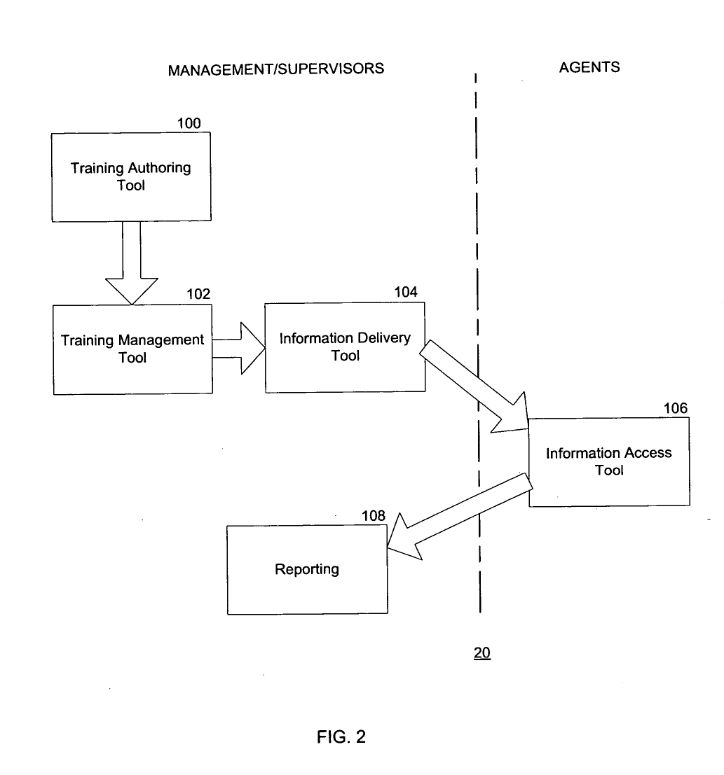

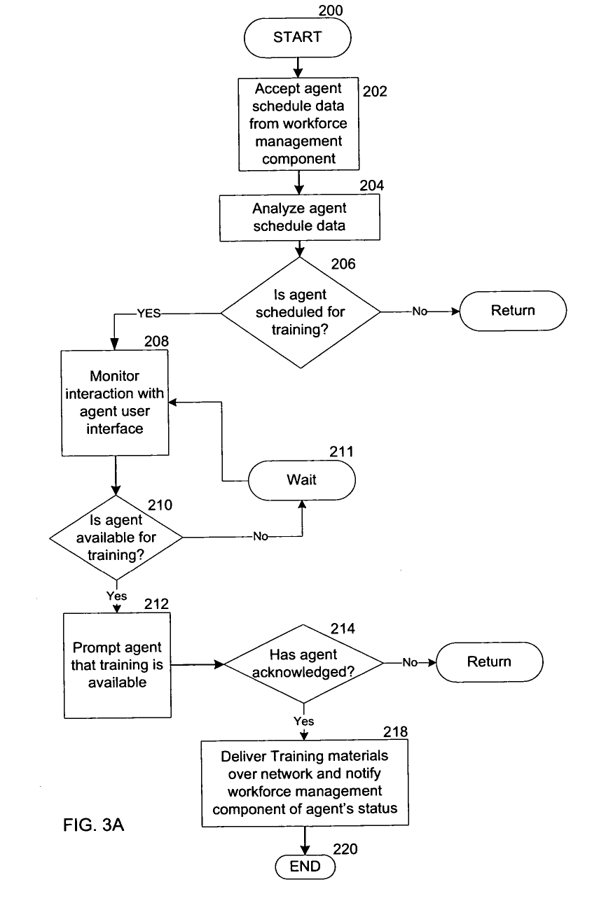

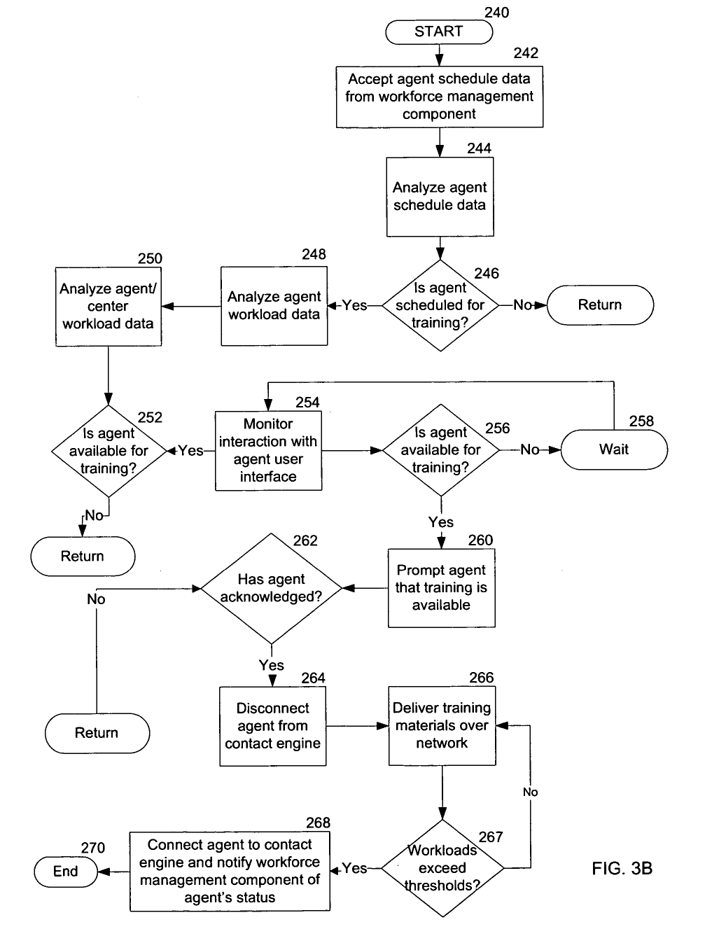

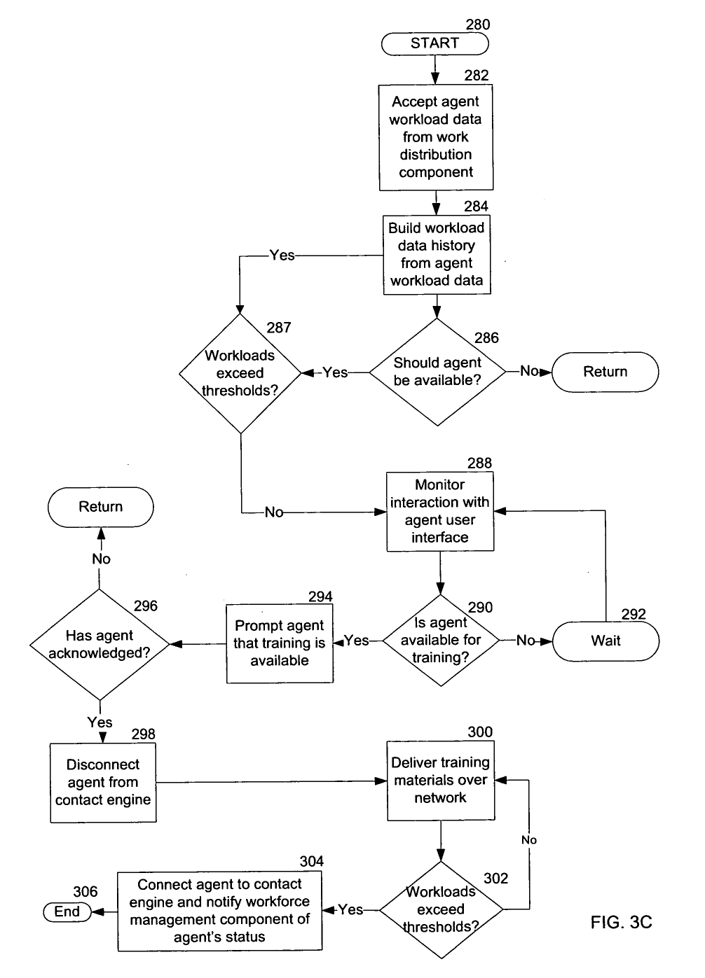

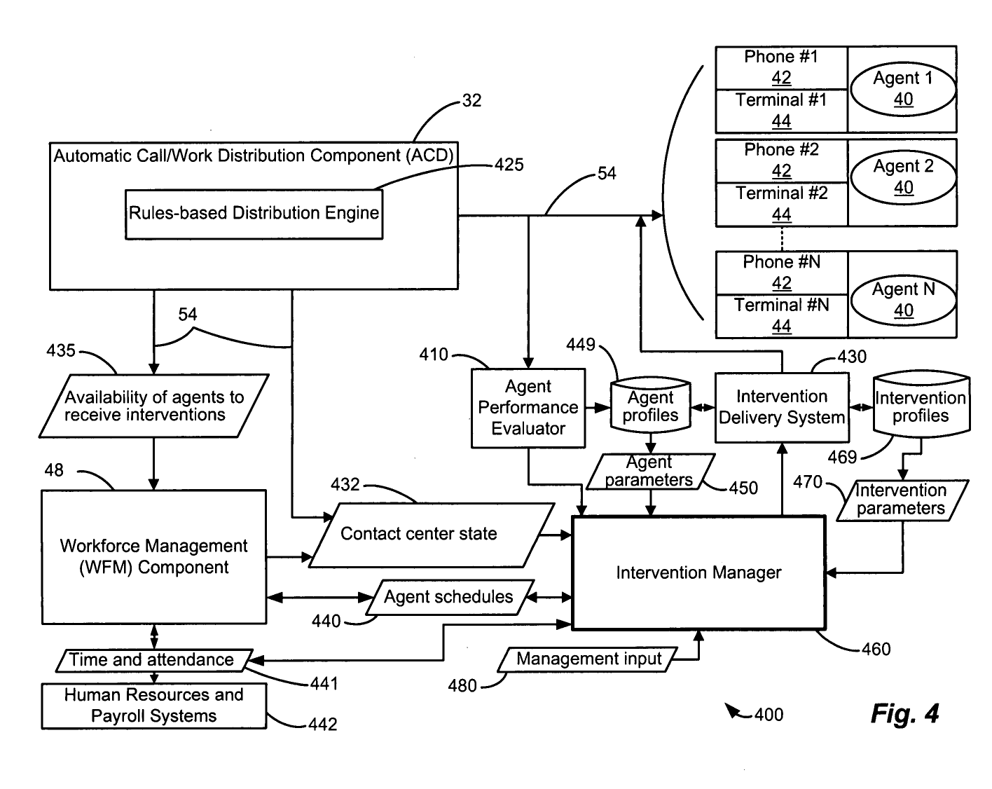

Turning now to the drawings, an exemplary embodiment of the invention will be described. FIG. 1 provides a contact center as an exemplary environment for practicing an embodiment of the present invention. FIG. 2 provides a training system. FIG. 3 provides processes or methods for agent training. FIGS. 4-15 provide functional block diagrams, graphs, and flowcharts for using contact center state as a basis for selecting or sequencing performance interventions and/or for determining a performance intervention delivery rate. An exemplary embodiment for prioritizing or sequencing performance interventions can comprise one or more of the elements, systems, methods, or technologies presented in any of FIGS. 4-15 (as well as other figures presented herein). Thus, a method or system for managing performance interventions that takes into account contact center state can establish a preferred sequence or prioritization for providing performance interventions.

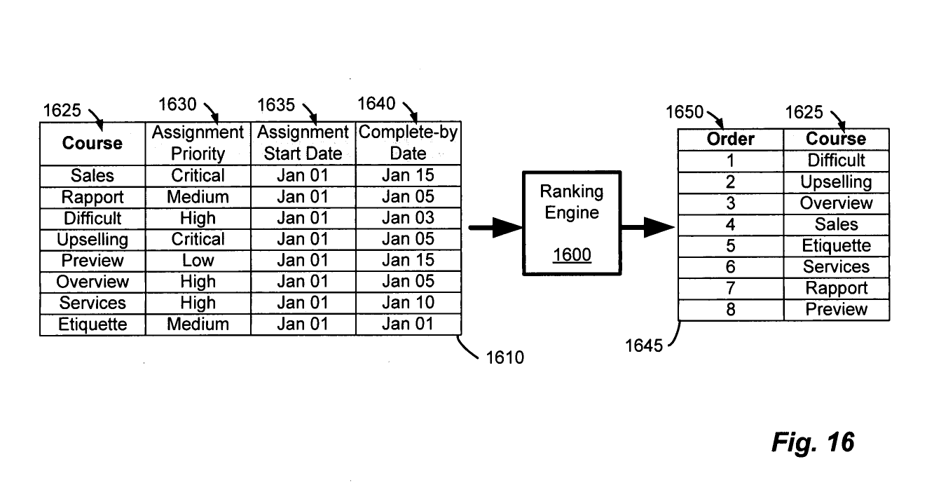

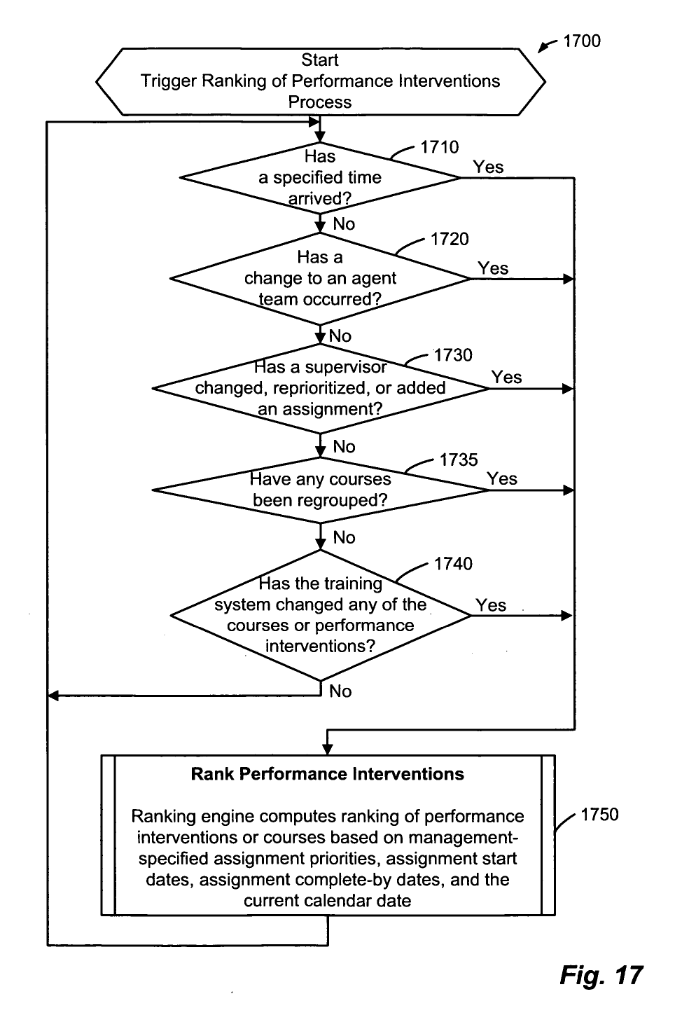

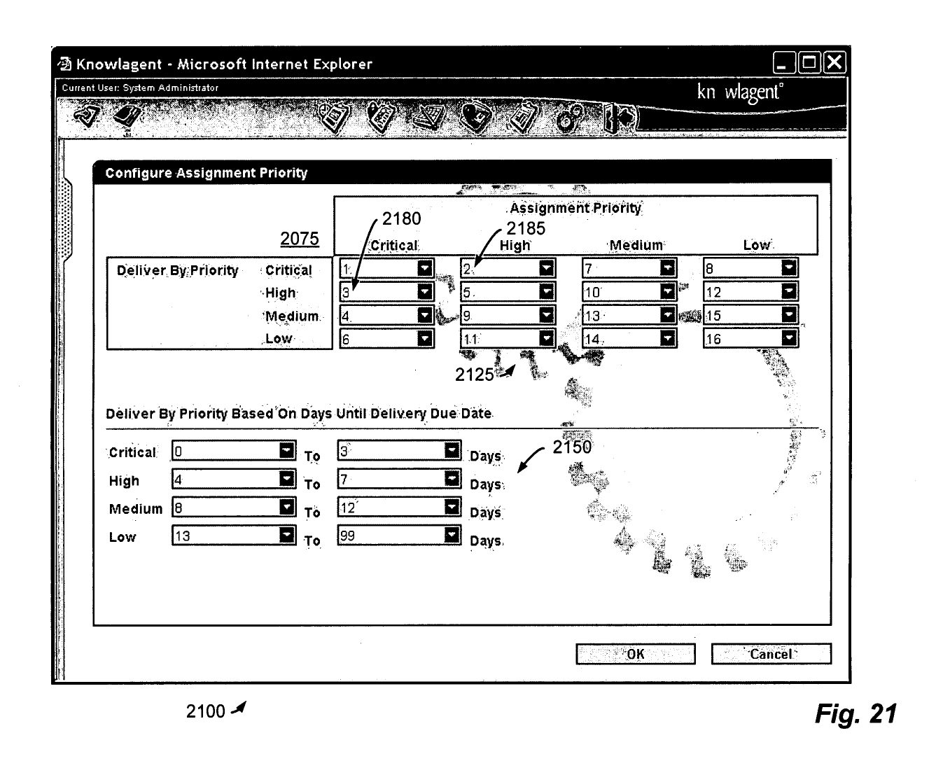

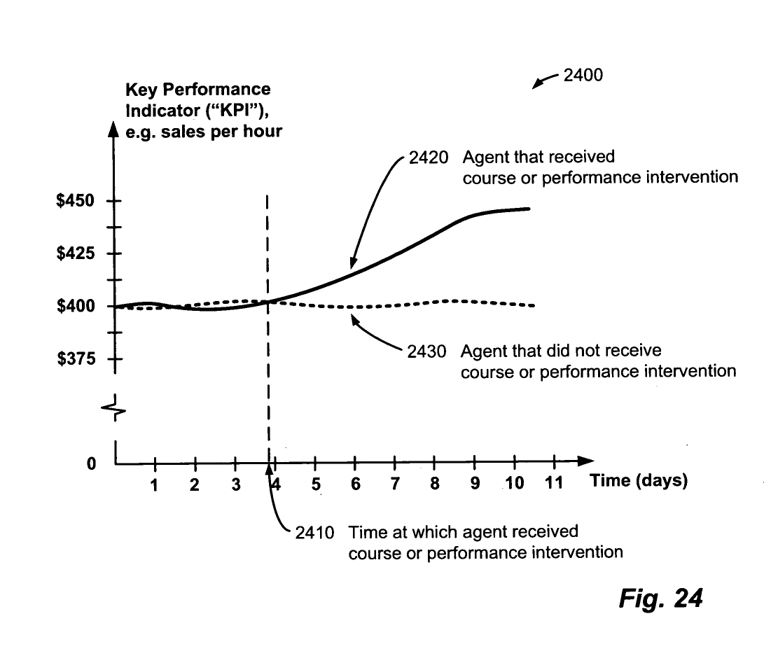

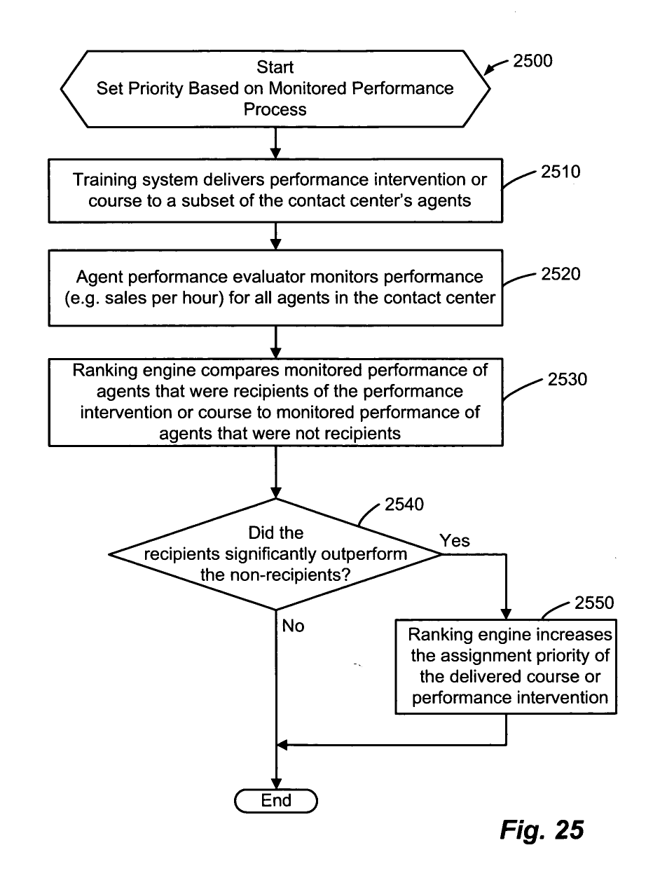

FIG. 16 provides an representative system for ranking, prioritizing, or sequencing performance interventions. FIGS. 17-20 provide representative processes and data structures for ranking, prioritizing, or sequencing performance interventions. FIGS. 21-23 provide representative GUI windows related to ranking, prioritizing, or sequencing performance interventions. FIGS. 24-25 provide a representative graph and a representative flowchart related to using monitored agent performance data as a basis for computing a preferred sequence for delivering performance interventions.

Turning now to FIGS. 1-3, these figures are directed to the scheduled delivery of content, such as training, to a constituent contact agent, such as a call center agent. Although FIGS. 1-3 will be described with respect to the delivery of training materials to an agent in a call center, those skilled in the art will recognize that the invention may be utilized in connection with the delivery of a variety of information in other operating environments.

FIG. 1 illustrates a computer system for managing a call center 10 in which one advantageous embodiment of the present invention is implemented. The illustrated call center 10 includes a training system 20 operative to schedule and deliver training materials to call center agents 40. In a typical application of the call center 10, a customer or contact 30 calls via the PSTN or other network to the call center 10. A network that links the customer or contact 30 to the call center 10 can comprise or utilize a wide area network (“WAN”), a virtual network, a satellite communications network, the Internet, a distributed computing network, an Internet telephony network, a voice-over-Internet protocol (“VoIP”) network, a packet-switched network, a private network, a LAN, an intranet, or other communications network elements as are known in the art.

The customer call may be initiated in order to sign up for long distance service, inquire about a credit card bill, or purchase a catalog item, for example. Through the PSTN 34, the call from the customer 30 reaches an ACD component 32 of the call center. The ACD component 32 functions to distribute calls from customers to each of a number of call center agents 40 who have been assigned to answer customer calls, take orders from customers, or perform other duties. Agents are typically equipped with a phone 42 and a call center computer terminal 44 for accessing product information, customer information, or other information through a database. For example, in a call center implemented to support a clothing catalog, the terminal 44 for an agent could display information regarding a specific item of clothing when a customer 30 expresses an interest in purchasing that item.

Customer phone calls and relevant database information are integrally managed by modern call centers 10 through CTI. A CTI component 34 enables the call center 10 to extract information from the phone call itself and to integrate that information with database information. For example, the calling phone number of a customer 30 may be used in order to extract information regarding that customer stored in the call center database and to deliver that customer information to an agent 40 for the agent's use in interacting with the customer. CTI 34 may also interact with Intelligent Voice Response (“IVR”) unit 36, for example to provide a touchtone menu of options to a caller for directing the call to an appropriate agent.

Depending on the nature and function of the call center, a constituent contact engine 38 is a software-based engine within the call center 10 that manages the interaction between customers and agents. For example, the constituent contact engine 38 may sequence the agent 40 through a series of information screens in response to the agent's information input during a customer call. The agent advantageously provides input to the constituent contact engine 38 through an agent user interface 46, which is typically a graphical user interface presented at a computer terminal 44.

A typical call center 10 includes a WFM component 48. WFM component 48 is used to manage the staffing of agents 40 in the call center 10 so that call center productivity can be optimized. For example, the volume of calls into or out of a call center 10 may vary significantly during the day, during the week, or during the month. WFM component 48 preferably receives historical call volume data from ACD component 32. The WFM component 48 can determine an appropriate level of staffing of agents 40 so that call hold times are minimized, on the one hand, and so that agent overstaffing is avoided, on the other hand.

In a typical call center, customer calls and interactions between customers and agents 40 are selectively sampled as part of a quality control program within the call center 10. This function is typically performed through a Quality Monitoring component 50 that monitors voice interaction through the agent's phone 42 and monitors information delivered through the system to the agent's terminal 44. In addition, Customer Relationship Management (“CRM”) systems 52 are often employed in call centers for a variety of marketing or customer service functions. For example, a CRM system 52 may be used to suggest to a caller ordering a certain book that the caller may wish to purchase other related books or other books that have been ordered by purchasers of the same book.

The call center 10 includes a communications network 54 to interconnect and link the aforementioned components. For a call center in which all elements are located at the same site, for instance, a local area network may provide the backbone for the call center communications network 54. In call centers for which the elements are geographically dispersed, the communications network may comprise a wide area network, a virtual private network, a satellite communications network, or other communications network elements as are known in the art.

The training system 20 according to one advantageous embodiment of the present invention is implemented in software and is installed in or associated with the call center computer system 10. By integration with the WFM component 48 and/or the CTI 34 of the call center, the training system 20 can deliver training material to agents 40 via communications network 54 in scheduled batches. Integration with the WFM component 48 and the CTI 34 enables the training system 20 to deliver training materials to agents at times when those agents are available and when training will not adversely impact call center performance. The training system 20 is also preferably in communication with quality monitoring component 50 through the communications network 54 so that training materials may be delivered to those agents who are most in need of training. Proficient agents are thus spared the distraction of unneeded training, and training can be concentrated on those agents most in need. Advantageously, call center management may set pass/fail criteria within the quality monitoring component 50 to trigger the scheduling of appropriate training to appropriate agents. This functionality may be provided via a rules engine implemented as part of the training system 20 or within the contact engine of the call center. By integrating with the CTI 34, the training system 20 can deliver training materials based on CTI-derived data such as customer call volume, independent of or complemented by the training schedule derived from the workforce management component 48 or the work distribution component 32.

In another advantageous embodiment of the present invention, the training system 20 may be deployed on a stand-alone server located remotely from call center 10. For example, training system could be deployed to serve a number of independent call centers 10, such as in a “web services” business model. In such a remote deployment, the problems of integration with individual call center computer systems can be avoided and the training system 20 can be maintained at a single central location.

A wide range of agent training scenarios can be supported by the training system 20. The training materials that are appropriate for a particular call center application can vary according to the call center function. The subject matter of training materials may also vary widely; for example, training materials may be focused on product information, phone etiquette, problem resolution, or other subjects.

FIG. 2 is a block diagram illustrating a training system 20 for the scheduling and delivery of training materials to call center agents 40 in a call center 10. The training system includes a number of interoperable software modules. Training authoring tool 100 is a software module that enables the managers of a call center to develop training materials, training courses, training quizzes, and other information to be delivered to agent 40 in the call center. Training system 20 preferably further includes a training management tool 102 that enables call center managers to assign agents to groups for training purposes, to assign training materials to individual groups, and to assign groups of courses to supersets of training groups.

The training system 20 preferably further includes an information delivery tool 104 that determines when the training materials assigned by the training management tool 102 are to be delivered to agents. The information delivery tool 104 preferably receives agent workload data and call center load data from ACD 32 through CTI 34. The information delivery tool 104 also preferably receives agent schedule data from WFM 48. The training system further comprises information access tool 106 for delivering the training materials to agents over communications network 54 on a scheduled basis so as not to disrupt agent customer contact duties. Agent consumption of training and training quiz performance are tracked by the reporting module 108, which is preferably adapted to generate standard and custom reports to enable call center managers and supervisors to more effectively manage agent performance and training.

Turning now to FIGS. 1, 2, and 3A, the steps in a method for delivering scheduled training to a contact agent within a call center operating environment are illustrated in flowchart form. The method begins at step 200. At step 202, the information delivery tool 104 within training system 20 accepts agent schedule data from WFM component 48 of the call center computer system 10. The agent schedule data may be in many forms, but in one example the data includes agent assignments to the call center sorted by quarter-hour over a period of several days. At step 204, the training system 20 analyzes the agent schedule data provided by the WFM component 48 to determine whether the agent is schedule for training. The method then proceeds to step 206; if the agent is not scheduled for training, the “No” branch of the flowchart is followed and the method returns. If the agent is scheduled for training, then the “Yes” branch is followed to step 208, where the agent's interaction with the agent user interface is monitored by information delivery tool 104 of the training system 20. For example, mouse movements or keyboard activity at the agent user interface can be monitored to determine whether the agent is handling a customer call. The method then proceeds to step 210, where the training system 20 determines, from the user interface activity, whether or not the agent is available for training. If the agent is not available for training, the method proceeds through the “No” branch to a wait loop at step 211 and the agent's interaction with the agent user interface is again monitored at step 208. If the agent is available for training, the method proceeds through the “Yes” branch to step 212, at which step the agent is prompted by the training system that training is available. This prompt may, for example, take the form of a pop-up screen delivered to the agent's terminal displaying a message indicating that training is now available for the agent.

The method then proceeds to step 214 at which step the training system 20 looks for an acknowledgment from the agent that the agent is ready for training. If the agent has not acknowledged by a certain predetermined time, for example, then the method proceeds through the “No” branch and returns. If the agent does acknowledge that the agent is ready for training, the method proceeds through the “Yes” branch to step 218, at which step training materials are delivered to the agent by information access tool 106 within the training system 20 over the communications network 54. Preferably, the agent has logged off of the call center computer system contact engine 38 before the training materials are delivered. In this exemplary method, the training materials delivered can, for example, comprise a sequenced series of training segments each of limited duration that together form an integrated whole. Of course, the training materials can vary considerably from call center to call center as dictated by the function of the call center and the business supported by the call center 10. The training materials delivery step 218 may be set to terminate after a predetermined amount of time. The method then terminates at step 220.

Accordingly, the method according to one exemplary embodiment as illustrated in the flow diagram of FIG. 3A accepts and analyzes agent schedule data provided from the WFM component of a call center computer system in order to non-disruptively schedule and deliver agent training.

According to another advantageous embodiment, the steps in a method for managing a call center or other constituent contact system are illustrated in the flow diagram of FIG. 3B. According to this exemplary method, information from both the workforce management component 48 and the automatic call distribution component 32 are used by information delivery tool 104 within the training system 20 to non-disruptively schedule and deliver agent training. Referring now to FIGS. 1, 2, and 3B, the method begins at step 240. At step 242, the information delivery tool 104 accepts agent schedule data from a workforce management component 48 of the call center computer system 10. The method then proceeds to step 244, where the agent schedule data is analyzed by the training system, and then proceeds to step 246. If the training system 20 determines at step 246 that the agent is not scheduled for training, based on the analysis of the agent's schedule data, then the method proceeds through the “No” branch and returns. If the training system 20 determines at step 246 that the agent is scheduled for training, then the method proceeds through the “Yes” branch to step 248.

The information delivery tool 104 of the training system 20 accepts agent workload data at step 248 from the automatic call distribution component 32 or other work distribution component of the call center system. Moving to step 250, the training system 20 analyzes the agent workload data to determine whether the call center's workload metrics (such as call volume or hold time) exceed certain predetermined thresholds. If the call center or the individual agent are too busy for the agent to be available for training, the method proceeds through the “No” branch at step 252 and returns. If the analysis of the call center metrics indicates that the agent is available for training, the method proceeds through the “Yes” branch to step 254.

At step 254, the training system 20 monitors the agent's interaction with the agent user interface, such as by monitoring mouse movements or terminal keystrokes. The training system 20 thereby determines whether or not the agent is available for training at step 256. If unavailable, the method proceeds through the “No” branch to wait loop at step 258, and the agent's interaction with the agent user interface is again monitored at step 254. If the agent is available for training, the method proceeds through the “Yes” branch to step 260.

At step 260, the agent 40 is prompted by the training system 20 that training is available. The prompt to the agent may, for example, be in the form of a pop-up screen delivered to the agent's terminal 44 informing the agent that training is available. According to the method, the training system then waits for an acknowledgment by the agent that the agent is ready for training, as shown at step 262. If the agent does not acknowledge that it is available for training, the method proceeds through the “No” branch and returns. If and when the agent acknowledges the prompt, the method proceeds through the “Yes” branch to step 264 and the agent is disconnected from the contact engine 38 within the call center computer system 10 so that interference between the training session and customer calls can be avoided. At step 266, the information access tool 106 of training system 20 delivers training materials to the agent 40 over the communications network 54.

The information delivery tool 104 monitors the work distribution component 32 at step 267 and determines whether predetermined agent or call center workload thresholds are exceeded during training material delivery. If agent or call center thresholds are not exceeded, then training material delivery continues at step 266. If thresholds are exceeded at step 267, the agent is reconnected to call center contact engine 38 at step 268 to resume customer contact duties, and the method then terminates at step 270.

The agent workload data provided by the ACD 32 or other work distribution component in the method illustrated in FIG. 3B may take many forms. For example, the agent workload data may simply indicate that the level of call center activity within the system exceeds a certain predetermined threshold, and that no training for any agent is therefore appropriate at that time. As another example, the agent workload data may include individual workload data for each of several agents, indicating which, if any, agents are available for a training session. In any event, the agent workload data is preferably real-time or near real-time data reflecting the activity within the call center.

Workload thresholds for all agents as a group or for individual agents may be set advantageously by the manager of the call center depending on the needs of the particular call center. For example, if reports from the quality monitoring component 50 indicate that the quality of call center interactions with customers has declined over the past week, the thresholds may be adjusted so that training is provided even when the call center is relatively busy. Advantageously, these thresholds may also be set automatically as a function of data supplied by the quality monitoring component 50.

FIG. 3C illustrates the steps in a method according to another advantageous embodiment of the present invention. As shown in FIG. 3C, a method is provided for managing a constituent contact system for a call center based on workload data from a work distribution component, such as an ACD.

Referring now to FIGS. 1, 2, 3C, the method starts at step 280. At step 282, the information delivery tool 104 of the training system accepts agent workload data from the ACD 32 or other work distribution component. At step 284, the training system 20 builds a workload data history from the agent workload data supplied by the ACD 32. The workload data history may comprise, for example, data indicating the activity for all agents as a whole or for individual agents as a function of recent time. This data is advantageously used by the training system to forecast when and if all agents or some agents should be available for training at some point in the future. For example, if the workload data history indicates that call volume drops significantly between 10 p.m. and midnight on Fridays, then the training system can, by leveraging data from other systems, forecast that call volume will drop next Friday evening. The training system 20 can thereby determine if an agent should be available for training at some point in the future, such as next Friday evening, based on the workload data history.

If the training system 20 determines at step 286 that the agent should be available at an upcoming time, the method proceeds through the “Yes” branch to step 287. If the system forecasts at step 286 that the agent will not be available at the upcoming time, the method proceeds through the “No” branch and returns. At step 287, the training system monitors predetermined agent and call center workload thresholds. If those thresholds are not exceeded, the system proceeds to step 288. If those workload thresholds are exceeded, the system returns to step 284 and updates the workload data history.

At step 288, the training system 20 monitors the interaction of the agent 40 with the agent's user interface 46, such as mouse movements or keystrokes. If the training system 20 determines at step 290 that the agent is not interacting with the agent's user interface 46, then the method proceeds through the “Yes” branch to step 294. If the agent is interacting with the agent's user interface, then the method proceeds through the “No” branch from step 290 to the wait loop at step 292 and again monitors agent user interface activity at step 288. At step 294, the system prompts the agent that training is available. If the agent does not acknowledge the prompt at step 296, the method returns. If the agent acknowledges the prompt at step 296, the system disconnects the agent from the call center contact engine at step 298 and proceeds to step 300.

At step 300, training materials are delivered by the information access tool 106 to the agent 40 over the communications network 54. Workload metrics for the agents in the call center and for the call center as a whole are monitored according to step 302; if the workloads exceed predetermined thresholds, then the method proceeds through the “No” branch back to step 300 and the delivery of training materials continues. If, on the other hand, the workload levels through the training system increase beyond a predetermined threshold or a predetermined length for the training session is exceeded during the delivery of training materials to the agent, then the method proceeds through the “Yes” branch to step 304, and the agent is reconnected to the call center contact engine so that the agent can return to handling customer call. The method ends at step 306.

It should be emphasized that the illustration of a call center environment in the preceding discussion is an example of one common application that can take advantage of the present invention, but that the present invention is not limited to call centers or to the delivery of training materials. The methods provided by the present invention can be applied in any constituent contact environment and may include a variety of media through which contact with constituents may be made by the constituent contact system. For example, constituents or contacts may include, in addition to customers, the employees of an organization, sale representatives of an organization, suppliers of an organization, contractors of an organization, or other constituents or parties with which and organization interacts.

Moreover, according to one exemplary embodiment of the present invention, the medium of communication between the system and the constituents may include voice contact over the public switched telephone network, e-mail or voice communications provided through the Internet, Internet-based “chat” contact, video communications provided over the Internet or over private broadband networks, or other communications media and forms as are known in the art.

In addition, a method provided by one exemplary embodiment of the present invention includes the delivery of a broad range of information to constituent contact agents. In addition to the training materials described above by way of example, any sort of information amenable to distribution via a digital or analog communications network may be delivered in accordance with present invention. For example, new information, real-time video, streaming video, sporting event information, music, conference call voice and video information, or other text, audio, video, graphics, or other information may be delivered without departing from the invention.

According to another aspect of the present invention, a computer readable medium having computer executable instructions is provided that includes software components adapted to perform steps corresponding to the steps in the methods described herein. According to one exemplary embodiment, a scheduling component, a monitoring component, and a delivery component are provided. The scheduling component accepts agent schedule data from the training system or the other constituent contact system, including data regarding the assignment of an agent within the organization to perform communications duties via the system. The scheduling component also analyzes the agent schedule data to determine when the agent is scheduled to receive information and to schedule an information delivery session for the agent. The scheduling component may further sequence the delivery of performance interventions. The monitoring component monitors the agent's communications with constituents or contact, such as through monitoring a user interface, in order to determine whether or not the agent is available to receive the information. The delivery component is adapted to deliver information to the agent over the communications network at times when the agent is scheduled to receive information as well as available to receive information.

Thus, an exemplary embodiment of the present invention can schedule and/or sequence training or other information for delivery to agents of a call center or other constituent contact system or contact center. Training materials, performance interventions, or other information may be scheduled or sequenced and delivered to an agent without disrupting the agent's customer contact duties. Agent schedule data from a workforce management component or agent workload data from a work distribution component can be analyzed to decide whether or not an agent is scheduled for training or is available for training. A user interface on the agent's terminal may be monitored by the training system 20 to determine whether the agent is busy interacting with a constituent or contact. If the agent is not busy, training materials or other information can be delivered to the agent's desktop through the system's communications network. To avoid interference between a training session and the agent's customer service duties, the agent may be disconnected from the system's customer contact engine before delivery of the training materials. If the call center's call volume or other metric exceeds a predetermined threshold during the training session, the session may be discontinued so that the agent may return to the agent's customer call duties.

In addition to the exemplary embodiments discussed in connection with FIGS. 1-3, further embodiments of the present invention will be described with reference to FIGS. 4-15 and FIGS. 16-25. As discussed in further detail below with reference to FIGS. 16-25, the systems, methods, or components shown in one or more of FIGS. 1-25 can provide a preferred sequence for providing performance interventions to members of a contact center workforce. Following the cumulative teaching presented herein, a system comprising various elements disclosed in FIGS. 1-25 and/or the accompanying text, can prioritize, sequence, or rank performance interventions.

A performance intervention typically is a communication delivered, preferably via computer, to an agent with the intent to enhance the performance, proficiency, and/or effectiveness of that agent. Agent supervisors or other members of a contact center's workforce can receive performance interventions. A computer system can deliver the communication automatically or in response to a manual input. The communication may be delivered exclusively via computer; alternatively, a computer and a human can collaborate to deliver the communication. For example, the computer can print out a recommended coaching script, and a human can follow the script in delivering coaching via traditional verbal communication. CBT sessions are one example of performance interventions. Reprimands, rewards, advice, coaching, one-on-one coaching, peer-to-peer coaching, supervisor-to-peer coaching, notices, warnings, feedback, reports, compliance statistics, performance statistics, and acknowledgements are other examples of performance interventions.

The term “state” or “contact center state” is used herein to refer to factors that describe or effect the contact center's overall operations. Contact center state includes measurements related to workload or activity level such as current call volume, historical call volume, and forecast call volume, each of which is sometimes described seasonally or over another increment of time. Contact center state also includes performance of the contact center. Time metrics of a contact center's performance include average handling time, hold time, average waiting time for each incoming call, and the fraction of calls connected to an agent within a specific length of time following call receipt. Additional metrics of contact center performance include agent performance indicators aggregated to the entire center and/or the center's agent population. Customer satisfaction index, abandonment, service level, compliance statistics, revenue goals and actuals, service level, new product roll out schedules, management directives, natural disasters, and catastrophic events are further examples of contact center state.

The term “abandonment rate” refers to the fraction of contacts who are engaged with the contact center but disconnect communication with the contact center prior to receiving service from an agent. The term “call volume” or “contact volume” refers to the number of calls or contacts that are engaged with the contact center in a unit of time, such as per day, per hour, per minute, or per second. The term “hold time” refers to the length of time between the contact center engaging a contact and an agent of the contact center initiating service with the contact. For example, hold time in an inbound call center is the time that the caller must wait on hold prior to being connected to an agent. The term “service level” refers to the percentage of incoming inquiries that are addressed in a target period of time, such as 80% of incoming calls answered within ten seconds.

The term “state level” or “state level setting” is used herein to refer to a specified contact center state. For example, management can define a state level specifying that at least 80% of calls should be answered within twenty seconds and that a lower percentage of calls answered is unacceptable. A state level can also be a target or otherwise desired operational state. A “performance level” or a “performance level setting” is a state level setting for a performance-based state. “State range” is a range of states. Two examples of state ranges are the states that are above a specified state level and that states that are between an upper state level and a lower state level.

The term “contact center” is used herein to include centers, such as service centers, sales centers, and call centers that service inbound calls and/or outbound calls. A contact center can serve customers or constituents that are either internal or external to an organization, and the service can include audible communication, chat, e-mail, video, and/or other forms of communication. A contact center can be physically located at a single geographic site, such as a common building or complex. Alternatively, a contact center can be geographically dispersed and can include multiple sites with agents working from home or in other telecommuting arrangements.

A typical computer-based contact center is an information rich environment. A network of data links facilitates information flow between the center's component systems. By tapping this network, the present invention can access historical, current, and forecast information from various center components and utilize this information in the process for managing performance intervention delivery. Consequently, the present invention can be responsive to new situations in the contact center environment, to fluctuations in contact center activity, and to other changes in the center's state.

Although an embodiment of the invention will be described with respect to managing the delivery of performance interventions at a contact center, those skilled in the art will recognize that the invention may be utilized in connection with the deployment of a variety of resources in other operating environments. One example other than a traditional call center environment is a technical support center within an organization that serves employees or members. Those skilled in the art will further recognize that the present invention may be utilized in connection with servicing inbound and outbound contacts at a contact center.

More generally, the business function provided by a contact center may be extended to other communications media and to contact with constituents of an organization other than customers. For example, an e-mail help desk may be employed by an organization to provide technical support to its employees. Web-based “chat”-type systems may be employed to provide information to sales prospects. When a broadband communications infrastructure is widely deployed, systems for the delivery of broadband information, such as video information, to a broad range of constituents through constituent contact centers can be employed by many organizations.

Turning now to FIGS. 4-15, an exemplary embodiment of the invention involving using contact center state as a basis for managing performance interventions will be discussed. Managing performance interventions can comprise prioritizing performance interventions, for example for express delivery, or defining, specifying, computing, or establishing a preferred order for the delivery or transmission of multiple performance interventions.

FIG. 4 illustrates a system for managing a contact center 400 in which one advantageous embodiment of the present invention is implemented. A contact center 400 includes an arrangement of computer-based components coupled to one another through a set of data links 54 such as a network 54. While some contact center functions are implemented in a single center component, other functions are dispersed among components. The information structure of the contact center 400 offers a distributed computing environment. In this environment, the code that supports software-based process steps does not necessarily execute in a singular component; rather, the code can execute in multiple components of the contact center 400.

The communication network 54 of the contact center 400 facilitates information flow between the center's components. For a contact center 400 in which all elements are located at the same site, a LAN may provide the backbone for the contact center communication network 54. In contact centers 400 with geographically dispersed components, the communications network 54 may comprise or utilize a WAN, a virtual network, a satellite communications network, the Internet, a distributed computing network, an Internet telephony network, a VoIP network, a packet-switched network, an intranet, the PSTN, or other communications network elements as are known in the art.

In a typical application of the contact center 400, a customer or other constituent calls the contact center 400 via the public switched telephone network (not illustrated in FIG. 4) or other communication network. The customer may initiate the call in order to sign up for long distance service, inquire about a credit card bill, or purchase a catalog item, for example.

An ACD 32 receives incoming calls from the telephone network, holds calls in queues, and distributes these calls within the contact center 400. ACD software generally executes in a switching system, such as a private branch exchange. The private branch exchange connects customer calls to terminals 44 operated by contact center agents 40 who have been assigned to serve one or more specific queues, for example to answer customer complaints, take orders from customers, or perform other interaction duties. In alternative embodiments of the invention, the function of the ACD 32 can be replaced by other communications routers. For example, in a contact system 400 using email, an email server and router can distribute electronic messages.

The ACD 32 maintains one or more queues for holding each incoming call that is waiting to be routed to an agent 40, who will service the call. Upon receipt of an incoming call from a customer or other constituent, the ACD 32 categorizes the call and identifies, on the basis of the categorization, a specific queue to hold the call. The ACD 32 then places the call in the specific queue and selects one agent 40 to service the call from a group of agents assigned to service the specific queue. By activating a physical switch, the ACD 32 then routes the call to the select agent 40.

The ACD 32 uses a rules-based distribution engine 425 to categorize each incoming call by applying categorization rules to information that is known about the call. Based on the categorization, the ACD 32 matches the call with one of several queues. In other words, each queue holds a specific category of call. For example, one queue might hold calls from Spanish-speaking callers seeking to order flowers while another queue might hold calls from English-speaking callers seeking to order candy. The rules based distribution engine 425 includes software programs that select a specific agent 40 to receive the incoming call. The software programs match the call to an agent 40 who is available and has appropriate qualifications and performance history.

When the ACD 32 routes the call to an available agent 40, the agent 40 receives the call and communicates with the caller over a telephone 42 while entering and receiving information through a computer terminal 44. The terminal 44 provides the agent 40 with access to product information, customer information, or other information through databases. For example, in a contact center 400 implemented to support a catalog-based clothing merchant, the computer terminal 44 for an agent 40 could display information regarding a specific item of clothing when a customer expresses an interest in purchasing that item. Agents 40 can also view information about the call that the ACD 32 derived from the call when the call first came into the contact center 400. A desktop application, which is usually a customer resource management component (not explicitly shown in FIG. 4), facilitates an agent's interaction with a caller.

In addition to routing calls, the ACD 32 monitors and records call volume and call processing statistics, which are forms of contact center state 432. Thus, the ACD 32 is one type of monitor in the contact center 400 that provides contact center state 432. The ACD 32 provides current and historical measurements 432 of the number of calls that the contact center 400 receives for an increment of time, such as the number of calls received per second, per day, or per shift. The ACD 32 records the length of time 432 that each call waits in a queue before being serviced by an agent 40 and the length of each call. Upon query, the ACD 32 provides aggregate wait time statistics 432 for a specified period of time. The ACD also tracks after-call work, such as notes that an agent enters into the system after concluding service with a contact.

To support routing calls to agents 40 who are available to receive calls, the ACD 32 maintains an activity code for each agent 40. Each agent's activity code describes that agent's current activity. For example, an activity code may report that an agent 40 is servicing a call, idle and waiting to be connected to an incoming call, receiving a performance intervention, taking a break, or in after-call work.

In addition to describing the availability to receive an incoming call, the ACD's activity codes support determining each agent's availability to undertake specific activities. Thus, the ACD 32 maintains data 435 that describes each agent's availability to receive performance interventions. This data 435 is available via the contact center's network 54 to various systems in the center 400, including a WFM component 48.

The WFM component 48 manages the staffing level of agents 40 in the contact center 400 to support improving the contact center's productivity and profit. For example, the volume of calls into or out of a contact center 400 may vary significantly during the day, during the week, or during the month. The WFM component 48 can receive historical call volume data from the ACD 32 and use this information to create work schedules 440 for agents 40. WFM components 48 commonly employ the Erlanger Algorithm, which is known to those skilled in the art, to forecast scheduling resources. Historical call volume data 432 can be the basis for forecasting future call volume 432 and/or other forecasts of the contact center's state 432. The WFM component 48 can generate current and forecasted state 432 based on data from the ACD 32 and from its internal information regarding agent staffing.

In one embodiment of the present invention, the WFM component 48 receives current and historical call volume data 432 from the ACD 32. The WFM component 48 fits current and recent call volume data 432 to historical data patterns and projects this data 432 into the future to derive a forecasted call volume 432. In one embodiment of the present invention, this projection is based on a simple linear curve fit. The WFM component 48 overlays forecasted call volume 432 onto an agent work schedule 440 to provide a forecast of contact center performance 432.

The WFM component 48 also communicates time and attendance data 441 to the contact center's human resources and payroll system 442. This communication facilitates computing an agent's compensation based on that agent's activities. Agents 40 may receive bonuses upon complying with a goal, such as servicing calls for more than a specified percentage of the time in a shift. To avoid penalizing an agent 40 for time spent receiving a performance intervention, the WFM component 48 sends a record 441 of such time to the center's human resources and payroll systems 442. The human resources and payroll systems use this information 441 to compute the agent's compensation. In other words, the WFM component 48 communicates information 441 to the human resources and payroll system 442 to facilitate rewarding an agent 40 for productive activities and to avoid penalizing an agent 40 for mandated activities.

Also, an agent 40 in a contact center 400 may receive a bonus or variable pay based on how well the agent 40 adheres to a schedule. To avoid considering an agent 40 out of compliance during the delivery of a performance intervention, the WFM component 48 is notified of the intervention delivery.

As yet another example of coordinating and tracking activities in the contact center 400, the intervention delivery system 430 periodically synchronizes with the WFM component 48 and the ACD 32. The synchronization process includes synchronizing for time spent in training and compliance with training schedules. In one embodiment of the present invention, the intervention manager 460 executes this synchronization process.

An agent performance evaluator 410 provides measurements and indications of agent performance that are useful to management and to the various components of the contact center 400. The agent performance evaluator 410 stores these measurements and indications in the agent profiles database 449 and regularly updates them. That is, an agent profile, which is stored in the agent profiles database 449 can include one or more indications of an agent's performance. Various components of the contact center 400 can access this data though the contact center's network infrastructure 54.

In addition to agent performance data, an agent profile can include other agent parameters that describe an agent's capability to contribute to the contact center 40. For example, it can include a characterization of an agent's skills and competencies. Also, it can include an agent's traits, such as personality and cognitive traits.

The agent performance evaluator 410 typically determines the level of agent skill and competency in each of several areas by accessing information from the center components that collect and track agent performance information. Examples of these components include, but are not limited to, the intervention delivery system 430, the WFM component 48, the ACD 32, and a quality monitoring system (not illustrated in FIG. 4). The relevant skills and competencies for a contact center 400 serving a catalog clothing merchant could include product configuration knowledge (e.g. color options), knowledge of shipping and payment options, knowledge of competitor differentiation, finesse of handling irate customers, and multilingual fluency.

In one embodiment of the present invention, the agent performance evaluator 410 includes an agent performance ranking function that assigns a performance rank, or index, to each agent 40. The agent performance evaluator 410 stores each agent's rank in the agent profiles database 449 and provides a list of agents 40 ordered by performance rank to the intervention manager 460.

The agent performance evaluator 410 also stores raw monitoring data describing agent performance in the agent profiles database 449. This database 449 is typically maintained in a bulk storage drive or the hard drive of a LAN server, where the data is readily accessible to the intervention manager 460 as well as other devices in the contact center 400. Agent performance data includes raw performance statistics as well as aggregated statistics and derived metrics. The agent performance evaluator 410 also generates agent performance data based on performance-related information from various components in the contact center 400. For example, the agent performance evaluator can compute metrics of agent performance, which are characterizations of an agent's job performance, utilizing handling time statistics that are tracked by the ACD 32. Such statistics can be tracked by one or more of the other systems in the contact center 400, such as a customer resource management component (illustrated in FIG. 1 but not in FIG. 4). In one embodiment of the present invention, the agent performance evaluator 410 determines performance indicators such as: close ratio, first call resolution, quality, complaint ratio, cross-sales rate, revenue per call, and average handling time for each agent 40.

In one exemplary embodiment of the present invention, the agent performance evaluator 410 comprises a system that is physically dispersed in the contact center 400. In this configuration, the agent performance evaluator 410 can include the system components in the contact center 400 that contain agent performance information such as average handling time, close ratio, quality, etc. The intervention delivery system 430 uses performance monitoring data to ascertain performance gaps that exist for one or more agents 40 so that appropriate performance interventions can be assigned to address those gaps. Analyzing one or any combination of performance metrics can determine the need for performance interventions. For example, if an agent's revenue per call is below average, then the intervention delivery system 430 could elect to deliver sales tips.

The agent profiles database 449 includes agent performance indicators for each agent 40. Performance indicators for an agent 40 are metrics of that individual agent's actual on-the-job performance. Performance indicators include quality, call handling time, first call resolution, cross-sell statistics, quality, close ratio, revenue per hour, revenue per call, calls per hour, and speed of answer, for example. Agent performance reflects an aspect of an agent's demonstrated service of a real contact.

The agent profiles database 449 also includes agent qualifications data for each agent 40. Agent qualifications are distinct from agent performance. Agent qualifications reflect characteristics of an agent 40. Although agent qualifications are sometimes correlated to on-the-job performance, agent qualifications are not necessarily correlated to performance. For example, an agent who is highly trained on the technical aspects of diamonds may be an inept diamond seller as measured by actual, on-the-job performance. Agent qualifications include an agent's innate traits such as cognitive skills and personality. Agent qualifications also include an agent's skills and competencies. Foreign language fluencies, product expertise acquired by receiving performance interventions involving specific products, and listening skills are examples of an agent's skill and competency qualifications.

The intervention delivery system 430 and the agent performance evaluator 410 update the agent profile database 449 when new information is available from the various computer-based components in the contact center 400. In one embodiment of the present invention, the agent profiles database 449 preferentially includes real-time data regarding agent qualifications and performance indicators such as agent parameters data 450.

The term “agent parameters” as used herein refers to any characteristic of an agent 40 that is pertinent to performance intervention delivery. Agent performance, agent qualifications, work schedules, successful completion of performance interventions, time since last intervention, and performance intervention assignment are examples of agent parameters.

An agent's ability to impact the operational effectiveness of the contact center 400 is another example of an agent parameter. Agent parameters can also include an estimate or other indication of the benefit that the contact center 400 is likely to derive from delivering a performance intervention to a specific agent 40. In other words, delivering a performance intervention to an agent 40 should benefit the contact center by improving the contact center's long-term operational effectiveness. An agent parameter can be a relative or absolute characterization of such improvement or benefit.

An agent 40 who is a poor performer may realize significant performance improvement from one or more performance interventions. This may be especially true for new-hire agents who have high cognitive abilities and desire to excel. In contrast, a senior agent 40 who is a strong performer may gain only modest benefit from a performance intervention, especially if the performance intervention is not geared towards advanced instruction. Thus, selecting poor performers to preferentially receive performance interventions can benefit the contact center 400 as a whole. Nevertheless, certain poor performers may achieve little or no performance gain from an extensive regime of performance interventions. In other words, the agent population 40 may include agents 40 with a low propensity to improve with training or other performance interventions. An agent parameter that describes benefit to the contact center 400 derived from delivering a performance intervention to a specific agent 40 can reflect agent trainability as well as other considerations.

“Intervention assignment” or “performance intervention assignment” refers to the interventions that are assigned to be delivered to one or more agents 40.

The intervention delivery system 430 accepts performance monitoring input from the agent performance evaluator 410 via the agent profiles database 449 as feedback for agent performance intervention programs, such as training programs. In one embodiment of the present invention, the intervention delivery system 430 is a training system that delivers instructive content to agents 40. In one embodiment of the present invention, the intervention delivery system 430 is a CBT system that is implemented in software and coupled to the contact center's communications network 54. Under the control of the intervention manager 460, the intervention delivery system 430 delivers intervention content in a manner that promotes both the short- and long-term performance of the contact center 400. Furthermore, the intervention delivery system 430 delivers content to agents 40 at times when those agents are available and when the performance intervention will not adversely impact the contact center's operations.

The intervention delivery system 430 is also in communication with the agent performance evaluator 410 through the intervention manager 460 so that appropriate intervention content, such as training materials, may be delivered to the agents 40 who are most in need of receiving a performance intervention. Proficient agents 40 are thus spared the distraction of unneeded performance interventions, and interventions can be concentrated on those agents 40 most in need and on areas of greatest need for those agents 40. Contact center management may establish pass/fail or remediation thresholds to enable the assignment of appropriate performance interventions to appropriate agents 40. This functionality is provided within the intervention manager 460. Preferably, agent skills that are found to be deficient relative to the thresholds are flagged and stored in a storage device within the agent profiles 42.

The intervention delivery system 430 can assess various aspects of an agent's qualifications. By administering a traits test, the intervention delivery system 430 characterizes an agent's personality and cognitive abilities. A traits test is typically only administered once for each agent 40, since for most agents 40, cognitive ability and personality do not change dramatically during employment. By administering a skills and competencies test, the intervention delivery system 40 can identify knowledge gaps and determine agent qualifications that improve with training and on-the-job experience.

With an understanding of agent's skills and competencies, performance interventions can be administered to improve skills and competencies. Once the performance intervention is administered, an assessment can be provided to ensure the agent 40 understood and retained the content. In addition, the agent's performance can be monitored to determine if performance has changed based upon the acquisition of the new information. When the agent's performance has changed, the intervention delivery system 430 can automatically update the agent's skills and competencies in the agent profiles database 449, thereby maintaining an up-to-date view of agent qualifications. Similarly, the intervention delivery system 430 maintains an intervention profiles database 469 that holds intervention parameters 470 and other descriptive information regarding each performance intervention in the contact center's portfolio of performance interventions.

The term “intervention parameter” as used herein refers to any attribute of an intervention that is pertinent to intervention delivery. Examples of intervention parameters include length of intervention, priority of intervention, and requirement to deliver the intervention by a deadline.

In tandem with the agent performance evaluator 410, the intervention delivery system 430 can determine if an agent 40 effectively practices the subject matter of a completed performance intervention, such as a training session. Immediately following a computer-administered test, the results are available throughout the contact center's information network infrastructure 54.

Coupled to the information infrastructure 54 of the contact center 400, the intervention manager 460 accesses information from components and computer systems throughout the center 400 to ascertain the dynamic operating conditions of the center 400. Thus, the intervention manager 460 receives contact center state 432, agent parameter information, and intervention parameters 470 via the contact center network 54. The intervention manager 460 processes this information according to management input 480 using software programs to determine parameters for managing the delivery of performance interventions to contact center agents 40.

The intervention manager 460 computes the rate of delivering performance interventions to agents 40 based on these inputs, 432, 449, and 470, and management input 480. The number of performance interventions delivered for an increment of time is a function of contact center state 432. The intervention delivery system 430 implements the delivery of performance interventions according to the rate set by the intervention manager 460.

If contact center state 432 indicates that contact center operations are below a desired level 480, such as a management input performance target 480, the intervention manager 460 decreases the rate of performance intervention delivery. Decreasing the rate of performance intervention delivery increases the number of agents 40 who are available to service contacts, thereby improving operational effectiveness and efficiencies.

If contact center state 432 indicates that the performance of the contact center 400 is higher than required, the intervention manager 460 increases the rate of performance intervention delivery, thereby diverting agents 40 from servicing contacts and engaging them to receive performance interventions. In this manner, the contact center 400 enhances the capabilities of its agents 40 without compromising the center's short-term performance.

In addition to setting the rate of performance intervention delivery, the intervention manager 460 selects the performance interventions that the performance intervention delivery system 430 delivers to agents 40. To make the selection, the intervention manager 460 compares state 432 of the contact center 400 to intervention parameters 470 and management input 480. Using contact center state 432 as a factor in selecting interventions provides responsiveness to dynamic conditions in the contact center 400.

The intervention manager 460 computes the selection of performance interventions based on intervention priority, which is an intervention parameter 470, one or more state levels 480, which are management inputs 480, and contact center state 432, such as operational performance. The intervention manager 460 can also select interventions based on other intervention parameters 470, such as intervention length or intervention cost. Furthermore, the intervention manager 460 can select performance interventions that best serve the operational effectiveness of the contact center 400. For example, the intervention manager 460 can select one performance intervention over another intervention based on an estimate that the selected performance intervention will yield more benefit to the contact center 400.

At any time, the contact center 400 typically maintains a list of performance interventions for which delivery is desirable. The performance interventions in the list have a range of priorities, or importance of delivery. In other words, delivery is critical for certain performance interventions and less important for others. The list can be organized to reflect a preferred sequence or order for performance intervention delivery.

Intervention priority can be set by management to define or specify the relative importance or time-sensitive aspects of certain performance interventions relative to other others. For example, in advance of a seasonal sales flurry, such as selling flowers for Valentines Day, management may elect to define a flower-selling instructional session as a critical-priority performance intervention.

If performance 432 of the contact center 400 is lower than desirable, the intervention manager 460 can elect to deliver only performance interventions having critical delivery requirements. Consequently, when the contact center 400 is not operating as smoothly as desired, the intervention manager 460 avoids unnecessarily diverting an agent 40 from servicing contacts to receiving performance interventions. This function promotes the short-term performance of the contact center 400. When the contact center 400 is operating better than required, the intervention manager 460 can be more liberal in its selection of performance interventions.

The contact center performance levels 480 that are thresholds for selecting performance interventions based on priority are management inputs 480. Personnel in the contact center 400 typically set these levels 480 according to managerial objectives; however, a computer program can also define and/or adjust the state level settings 480. In other words, either a human or a machine in the contact center 400 can provide management input 480 to the intervention manager 460.

In addition to selecting and/or sequencing performance interventions and pacing intervention delivery, the intervention manager 460 selects agents to receive performance interventions based on agent need. The intervention manager 460 can elect to deliver performance interventions on a priority basis to low-performing agents 40. Concentrating performance interventions on low-performance agents 40 typically increases the aggregate performance of the agent population 40 more than evenly distributing performance interventions amongst the agent population 40. That is, the intervention manager 460 selects agents 40 to receive performance interventions to serve the operational goals of the contact center 400 as a whole.

In one embodiment of the present invention, the intervention manager's agent selection includes a sequence of agents 40 to receive performance interventions. For example, the sequence follows the ranked order of agent performance, starting with the lowest performing agent 40 and progressively sequencing towards the best performer. The intervention delivery system 430 receives the sequence from the intervention manager 460 and delivers performance interventions accordingly.

Those skilled in the information-technology, computing, or contact center arts will recognize that the components, data, and functions that are illustrated as individual blocks in FIG. 4 (or in the other figures) and discussed herein are not necessarily well defined modules. Furthermore, the contents of each block are not necessarily positioned in one physical location of the contact center 400. In one embodiment of the present invention, the blocks represent virtual modules, and the components, data, and functions are physically dispersed. For example, in one embodiment of the present invention, the contact center state 432, the agent parameters 450, the agent availability data 435, the agent schedules 440, and the intervention parameters 470 are all stored on a single computer readable medium that can be offsite of the contact center 400 and accessed via a WAN.

In one embodiment of the present invention all of the computations and processes related to managing performance intervention delivery are stored on a single computer readable medium and executed by a single microprocessor. In yet another embodiment, multiple contact center components each execute one or more steps in the intervention management process. In general, the present invention can include processes and elements that are either dispersed or centralized according to techniques known in the computing and information-technology arts.

The present invention includes multiple computer programs which embody the functions described herein and illustrated in the exemplary flowcharts, graphs, tables, and diagrams of FIGS. 1-25. However, it should be apparent that there could be many different ways of implementing the invention in computer programming, and the invention should not be construed as limited to any one set of computer program instructions. Further, a skilled programmer would be able to write such a computer program to implement the disclosed invention without difficulty based on the exemplary data tables and flowcharts and associated description in the application text, for example.

Therefore, disclosure of a particular set of program code instructions is not considered necessary for an adequate understanding of how to make and use the invention. The inventive functionality of any claimed computer program will be explained in more detail in the following description in conjunction with the remaining figures illustrating the functions and program flow.

Certain steps in the processes described below must naturally precede others for the present invention to function as described. However, the present invention is not limited to the order of the steps described if such order or sequence does not alter the functionality of the present invention. That is, it is recognized that some steps may be performed before or after other steps or in parallel with other steps without departing from the scope and spirit of the present invention.

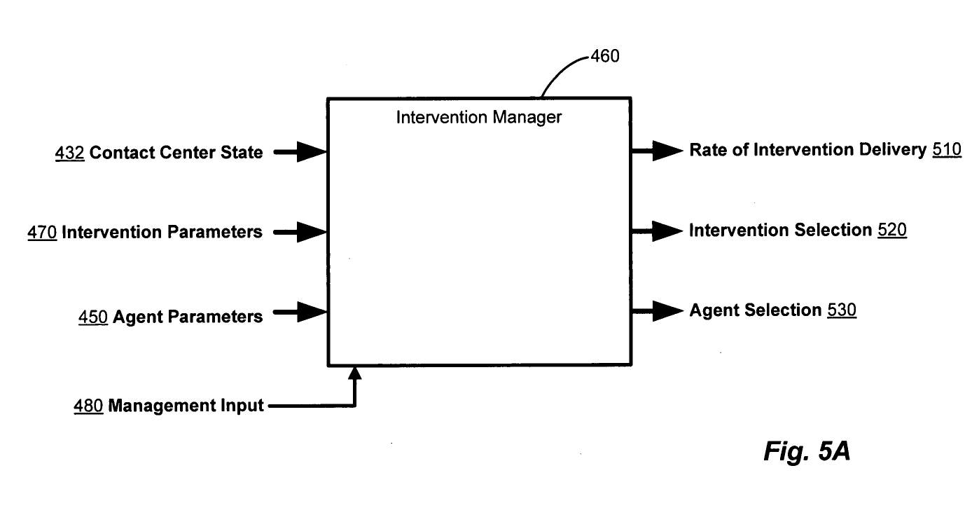

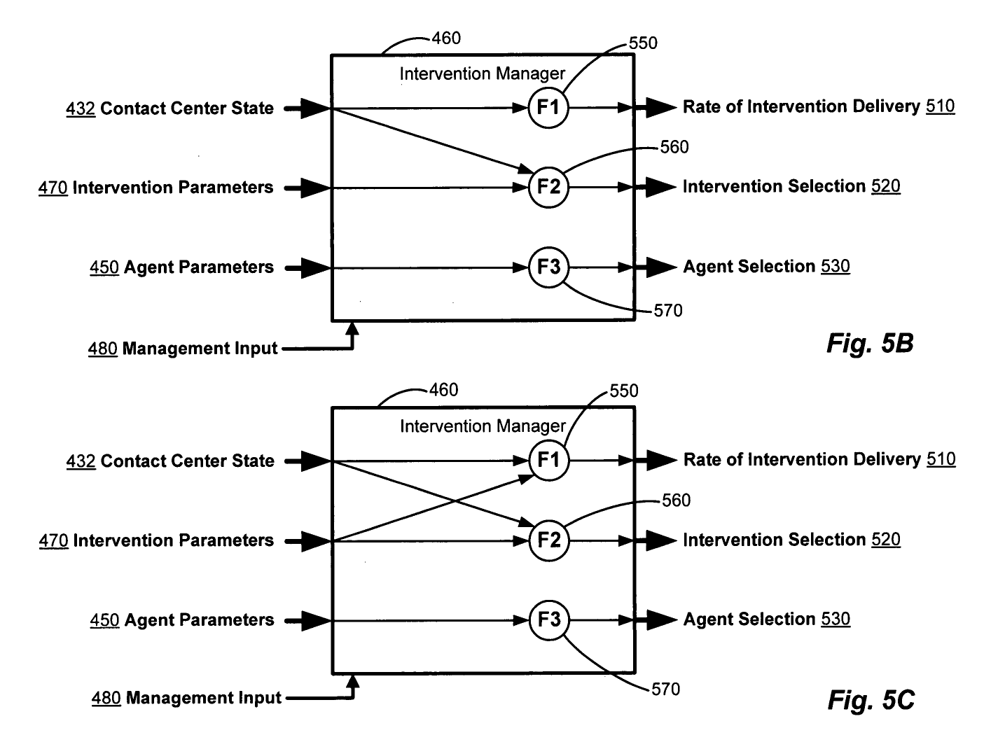

FIG. 5A illustrates primary inputs and primary outputs of an intervention manager 460 according to one exemplary embodiment of the present invention. Contact center state 432, intervention parameters 470, and agent parameters 450 are primary inputs to the intervention manager 460. The intervention manager 460 processes these three primary inputs, 432, 450, and 470, to provide three primary output parameters, 510, 520, and 530, to the intervention delivery system 430, which responds accordingly. In other words, the intervention manager 460 controls performance intervention delivery by outputting controlling inputs 510, 520, 530 to the intervention delivery system 430. The primary inputs, 432, 470, and 450, and the primary outputs, 510, 520, and 530, of the intervention manager 460 can each be a single value or an array of values, such as a vector or a matrix of numbers.

Contact center state 432, the first of the three primary inputs 432, 470, 150 to the intervention manager 460, is a measurement of operational performance in the contact center 400, according to one embodiment of the present invention. Exemplary performance metrics include average wait time and percentage of calls connected to an agent 40 within a preset period of time, such as twenty seconds. In another embodiment of the present invention, contact center state 432 is a measurement of load, or call volume.

Intervention parameters 470, the second of the three primary inputs to the intervention manager 460, are attributes of each performance intervention that are pertinent to intervention delivery. In one embodiment of the present invention, the priority of each performance intervention is the intervention parameter 470 that the intervention manager 460 uses for its output computations. That is, a performance intervention's priority designates the importance of delivering that intervention, and the intervention manager 460 manages intervention delivery based on that priority designation.

Priority categories, such as critical, high, medium, and low categories, designate performance interventions with similar delivery importance. Alternatively, the contact center's management prioritizes performance interventions by ranking each performance intervention according to the relative importance of its delivery. An index value can represent this ranking. In one embodiment of the present invention, a continuous scale specifies the priority of each performance intervention.

In addition to priority, intervention parameters 470 can include performance interventions assignments, intervention content, and intervention length. For example, management may assign performance interventions to specific agents 40. Intervention content can include the subject matter of a training session, such as instructing agents 40 to sell roses to contacts who are placing incoming calls to the contact center 400 during the Valentines season.

Agent parameters 450, the third of three primary inputs 432, 470, 450 to the intervention manager 460, includes the aspects of each agent 40 that are pertinent to performance intervention delivery. Agent parameters 450 include agent performance. In one embodiment of the present invention, agent performance includes each agent's ranked performance. That is each agent 40 is assigned a number that ranks his/her ordered performance, spanning from best to worst. Agent parameters 450 also include a list of the performance interventions that each agent 40 has previously received. In one embodiment of the present invention, agent parameters can also include each agent's work schedule 440, which is available from the WFM component 48. Agent parameters 450 can also include skills and competencies and traits.

Rate of performance intervention delivery 510, the first of the three primary outputs from the intervention manager 460, is the number of performance interventions delivered over an arbitrary increment of time, such as per second, minute, hour, day, or shift. This primary output 510 sets the frequency with which the intervention delivery system 430 delivers performance interventions. The rate of performance intervention delivery 510 measures the number of performance interventions for which delivery is initiated. Alternatively, the rate of performance intervention delivery 510 measures the number of performance interventions completed.

Intervention selection 520, the second of the three primary outputs from the intervention manager 460, is the determination of which performance interventions are delivered by the intervention delivery system 430 to at least one agent 40. In one embodiment of the present invention, performance intervention selection 520 is a subset of performance interventions assigned for delivery by management of the contact center 400. In one embodiment of the present invention, intervention selection 520 specifies a group of performance interventions, such as a prioritization category. That is, intervention selection 520 can instruct the intervention delivery system 430 to select a critical, a high, a medium, or a low priority performance intervention for delivery. Furthermore, an intervention selection 520 can specify that the intervention delivery system 430 is to deliver multiple performance interventions that have a defined combination of priorities.

Agent selection 530, the third of the three primary outputs from the intervention manager 460, is the determination of the agents 40 to whom the intervention delivery system 430 delivers performance interventions. In one embodiment of the present invention, agent selection 530 is an ordered sequence of agents 40. Agent selection can also be based on a worst-to-best ordered ranking of agents, the time lapse since each agent received a performance intervention, or the ages of performance intervention assignments. For example, an agent 40 who was assigned a performance intervention several weeks earlier can receive his/her performance intervention rather than another agent 40 who received the performance intervention a few hours earlier.

The intervention manager 460 also includes provisions to accept management inputs 480. Management inputs 480 are settings or values that adjust the intervention manager's computations and processes. That is, management input 480 can be a vehicle to modify or define the functional relationships between the primary inputs 432, 470, 450 and the primary outputs 510, 520, 530 of the intervention manager 460. In one embodiment of the present invention, the contact center's personnel enter the management inputs 480 through a computer terminal. In another embodiment of the present invention, one or more of the contact center's computer-based systems automatically compute and provide the management input 480 to the intervention manager 460.

In one embodiment of the present invention, management input 480 is a contact center state level 480. The intervention manager 460 compares the primary input contact center state 432 to the contact center state level 480 and adjusts at least one of the primary outputs 510, 520, 530 on the basis of the comparison.

FIG. 5B illustrates functional relationships between the three primary inputs 432, 470, 450 and the three primary outputs 510, 520, 530 of the intervention manager 460 according to one embodiment of the present invention. Function F1 550, Function F2 560, and Function F3 570 describe the processes through which the intervention manager 460 computes intervention delivery parameters 510, 520, 530, which are output to the intervention delivery system 430.

As illustrated in FIG. 5B, the intervention manager 460 computes the rate of performance intervention delivery 510 on the basis of contact center state 432 using Function F1 550. That is, contact center state 432 is the primary input variable that process F1 550 uses to compute the rate of performance intervention delivery 510. Management input 480 is another input to the F1 process 550. Contact center personnel can enter a contact center state level 480 into the intervention manager 460 as management input 480. Process F1 550 increases the rate 510 of performance intervention delivery 510 when measured contact center state 432 falls below the state level 480 and decreases the rate 510 when measured state 432 rises above the state level 480.

Function F2 560 computes the selection 520 of performance interventions based on contact center state 432 and intervention parameters 470. According to an exemplary embodiment of the present invention, this function 560 is a process 560 that compares the state 432 of the contact center 400 to one or more state levels 480, which are management inputs 480. The process 560 applies rules to the results of the comparison to determine the characteristics of the performance interventions that are to be delivered to agents 40. To select specific performance interventions with these characteristics, the intervention manager 460 searches the performance interventions that are eligible for delivery and identifies one or more matches. A performance intervention may be eligible for delivery if it is assigned to at least one agent 40, for example.

In an exemplary embodiment, the Function F2 process 560 includes rules that determine a suitable priority 520 of intervention that should be delivered based on the state 432 of the contact center 400. For example, if the contact center's performance 432 is within a certain performance band 480, the rules restrict intervention delivery to interventions having a specified priority category that corresponds to the band. Applying the specified priority 520 to the intervention parameters 470 of eligible performance interventions, the process 560 identifies a performance intervention having a suitable priority. The intervention delivery system 430 then delivers the identified performance intervention to one or more agents 40.

Function F3 570 computes the selection 530 of agents 40 who are to receive performance interventions. In one embodiment of the present invention, the intervention manager 460 coordinates selecting agents 40 with determining intervention delivery rate 510. In another embodiment of the present invention, the intervention manager 460 coordinates selecting agents 40 with selecting performance interventions. In yet another embodiment of the present invention, the intervention manager 460 coordinates selecting agents both with selecting performance interventions and with determining intervention delivery rate 510. In other words, the intervention manager 460 can coordinate Function F3 370 with Function F2 560, with Function F1 550, or with Function F2 560 and Function F1 550.

To select agents 530 to receive performance interventions, Function F3 570 accesses agent parameters 450 to determine which agents 40 have the greatest need for performance interventions. In one embodiment of the present invention, the intervention manager 460 correlates agent need for performance intervention to agent performance. The intervention manager 460 ascertains agent performance from the agent performance evaluator or from agent profiles database 449.

FIG. 5C illustrates exemplary input-to-output functional relationships of the intervention manager 460, according to another embodiment of the present invention. In this exemplary embodiment, the rate of intervention delivery 510 is a function not only of the contact center state 432, but also of intervention parameters 470, such as intervention priority or delivery sequence. In this embodiment, the intervention manager 460 can elect to accelerate the delivery of performance interventions when intervention parameters 470 warrant such accelerated delivery. For example, the contact center 400 may face a deadline to deliver one or more performance interventions that are time sensitive or otherwise critically important. The intervention manager 460 can respond to meet the deadline by increasing the number of performance interventions delivered during a time period preceding the deadline.

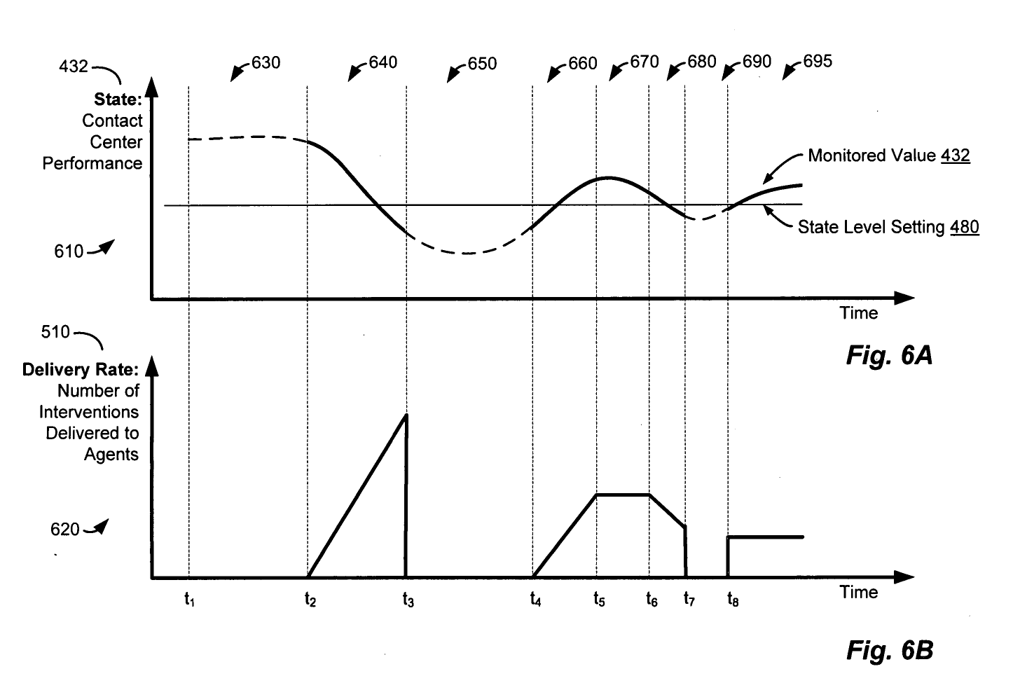

FIG. 6 illustrates the intervention manager 460 adjusting the rate of delivering performance interventions according to one exemplary embodiment of the present invention. The upper graph 610 presents monitored contact center state 432 and a management-input state level setting 480 over time. In this embodiment, contact center state 432 is contact center performance 432. In other words, the graph 610 illustrates the measured operational performance 432 of a contact center 40 as compared to a certain level 480. Without defining a specific metric of contact center performance 432, this graph 610 illustrates representative fluctuations of any of the contact center performance variables described herein. Furthermore, the upper graph 610 also illustrates contact center performance 432 responding to intervention delivery by the intervention delivery system 430 under management by the intervention manager 460.

The lower graph 620 illustrates the rate of intervention delivery 510 as set by the intervention manager 460 in response to the conditions illustrated in the upper graph 610. In other words, the lower graph 620 depicts the intervention manager 460 adjusting the rate of intervention delivery based on the monitored performance 432 of the contact center 400.

Together, the two graphs 610, 620 illustrate the interaction between the intervention manager 460 and the operating conditions 432 of the contact center 400, wherein operating conditions 432 are characterized by contact center state 432. That is, the graphs 610, 620 illustrate an exemplary sequence of actions and reactions between the intervention manager 460 and the operations of the contact center 400.

In one exemplary embodiment of the present invention, the intervention manager 460 controls the performance 432 of the contact center 400 with closed loop control using monitored performance 432 as feedback for adjusting the rate 510 of intervention delivery. That is, in one representative embodiment, the present invention monitors the current performance 432 of the contact center 400 and dynamically manipulates the number 510 of performance interventions delivered in an increment of time so as to control performance 432 to a desired level 480.

At the time period 630 between t₁ and t₂, contact center performance 432 is significantly above a performance level setting 480, which is a management input 480. These conditions suit the delivery of performance interventions, since at least some agents 40 can be diverted from servicing contacts while maintaining acceptable contact center performance 432. At time t₂, the intervention manager 460 elects to initiate delivering performance interventions. Manual intervention by contact center personnel, such as by an administrator or a manager, can prompt this initiation. Alternatively, either the intervention manager 460 or another computer-based system in the contact center 400 can trigger the delivery of performance interventions at time t₂.

At time t₂, the intervention manager 460 begins ramping the rate 550 of delivering performance interventions. That is, in the time period 640 between time t₂ and time t₃, the intervention manager 460 progressively increases the number 510 of interventions delivered per increment of time from zero upward. As agents 40 suspend servicing contacts and begin receiving performance interventions, monitored contact center performance 432 declines and ultimately falls below the management input state level setting 480.

At time t₃, the intervention manager 460 determines that contact center state 432 has fallen unacceptably below the state level setting 480 and ceases delivering performance interventions. In one embodiment of the present invention, ceasing delivering performance interventions entails terminating performance interventions that are in progress. Such termination can follow a specific agent sequence. The agent termination sequence can proceed according to management input, last-in-first-out, first-in-last-out, worst-agent-to-best-agent, time since last performance intervention, or other formula. In an alternative embodiment, ceasing initiating new performance interventions curtails the rate 550 of intervention delivery, for example smoothly decreasing the rate of delivering performance interventions until contact center state 432 recovers to an acceptable level 480.

At time t₃, the rate 510 of performance delivery is higher that the current conditions of the contact center 400 can support while maintaining an acceptable level 480 of operational performance. One or multiple factors can contribute to such unacceptable operational performance at time t₃. For example, an unexpected spike in call volume during the time frame 640 might cause hold time to increase unacceptably. A random increase in the length of time required to service contacts during the time frame 640 might cause wait time to increase, even with constant call volume. Even with constant contact center conditions during the time frame 640, the intervention manager 460 increasing the deliver rate 510 too aggressively might cause unacceptable performance.

Regardless of the cause of the unacceptable performance, the graphs 610, 620 illustrate the intervention manager 460 adapting to unacceptable performance and implementing corrective action by changing the rate 510 of delivering performance interventions to zero at time t₃.

During the time period 650 between time t3 and time t4, performance 432 of the contact center 400 recovers as the center's operations respond to the intervention manager 460 reducing the rate 510 of intervention delivery. After the intervention manager 460 changes the rate 432 to zero at t₃, performance 432 continues to decline before peaking at a minimum value and then improving. The time delay between setting the rate 510 to zero and the state 432 recovering may be due to interventions that are already in the delivery pipeline at time t₃.

At time t₄, contact center performance 432 is improving strongly towards passing the state level setting 480. At this point, the intervention manager 460 elects to reinitiate delivering performance interventions. During the time period 660 between time t₄ and time t₅, the intervention manager 460 ramps the rate 510 of delivering performance interventions more gradually than during the time period 640 between t₂ and t₃. This adjustment of the ramp slope illustrates the intervention manager 460 adapting to the fluctuations in the dynamic responsiveness of the contact center 400.

At time t₅, the intervention manager 460 elects to deliver interventions at a constant rate. At the time period 670 between t₅ and t₆, contact center performance peaks and then begins to decline. By time t₆, performance 432 approaches the state level setting 480. At this point, the intervention manager 460 begins to taper off the rate 510 of intervention delivery.

The rate reduction continues during the time period 680 between time t₆ and time t₇. At time t₇, the intervention manager 460 determines that the rate reduction is insufficient to maintain desired performance and sets the rate 510 to zero. The insufficiency of the prescribed rate reduction might result from a perturbation in the number of incoming calls, for example.

During the time period 690 between time t₇ and time t₈, contact center performance 432 increases above the state level setting 480. At time t₈, the intervention manager 460 resumes delivering performance interventions. In one embodiment of the present invention, the intervention manager's processes 550 compute this rate 510 based on the contact center's response to previous rates 510. In other words, the intervention manager 460 can analyze and learn from the reactions of the contact center 400 to earlier performance intervention deliveries.

In the time 695 following time t₈, the intervention manager 460 delivers interventions at a constant rate 510. The performance 432 of the contact center 400 stabilizes to a level that is slightly above the state level setting 480. As conditions in the contact center 400 fluctuate beyond time t₈ and as managers update management inputs 480, the intervention manager 460 continues to adapt and respond accordingly. This flexible functionality serves both the need to maintain operational performance at an acceptable level and the need to enhance the performance capabilities of the contact center's staff of agents 40.

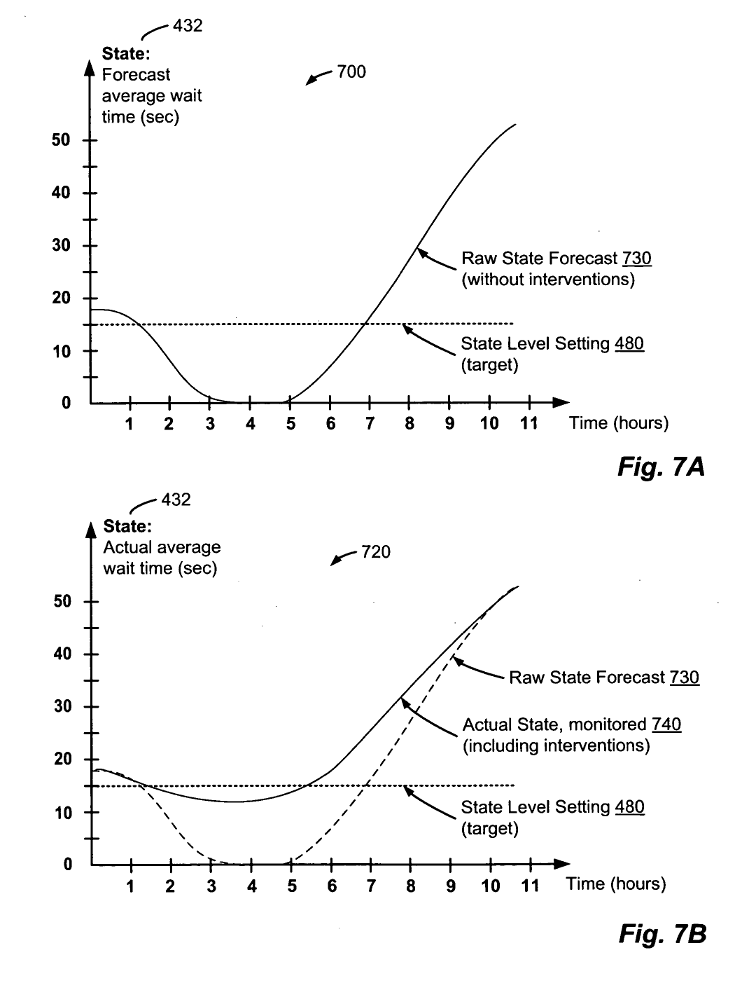

FIGS. 7A and 7B further illustrate the capabilities of the intervention manager 460 to adapt to changing conditions in the contact center 400 and to flexibly manage intervention delivery. These figures describe an embodiment of the present invention in which the intervention manager 460 manages intervention delivery based on forecasted contact center state 432.

FIG. 7A is a graph 700 that illustrates a projected state 432 of the contact center 400 from a current time, at hour zero, to eleven hours into the future. In this example, state 432 is average wait time, which is a performance metric that is typically a function of call volume. The graph 700 also presents a target state level 480, which is typically established through management input 480 and is set to the exemplary value of fifteen seconds. The target state level 480 is the level below which it is desirable to maintain average wait time. In other words, from a performance perspective, less wait time is better, and the intervention manager 460 controls intervention delivery so that wait time is less than fifteen seconds.

The illustrated forecast 730 of average wait time 432 is a raw forecast that does not include any change in average wait time 432 that may result from the delivery of interventions under management of the intervention manager 460. The forecast includes a time between hour one and hour seven during which the forecasted wait time falls significantly below the target level 480 of fifteen seconds. During this time, the intervention manager 460 has an opportunity to deliver interventions while maintaining acceptable wait time.

FIG. 7B is a graph 720 that presents the actual, monitored wait time 740 in conjunction with the raw wait time forecast 730 and the target wait time level 480 of the graph 700 illustrated in FIG. 7A. The combination of curves illustrates the intervention manager 460 using the lull in wait time as an opportunity to deliver performance interventions. In addition to establishing a rate 510 of delivering performance interventions, the intervention manager 460 can elect to take other managerial actions that will consume wait time 730. For example, the intervention manager 460 can use the lull as an opportunity to deliver longer performance interventions. Such actions can be taken in separately or in parallel with one another.

Between hours one and two, the intervention manager 460 begins delivering performance interventions or implementing other actions that consume the forecasted lull in wait time 730. Subsequently, the actual, monitored wait time 740 responds to the delivery of interventions and thereby increases. The actual wait time increases from a forecasted wait time 730 of zero seconds to an actual wait time 740 of approximately twelve seconds, which is acceptably below the target level 480 of fifteen seconds. In anticipation of the forecast rise in wait time that occurs after hour six, the intervention manager 460 can stop delivering performance interventions. After the intervention manager 460 stops delivering performance interventions, the monitored wait time 740 settles to overlay the forecast wait time 730 at approximately hour eleven.

As an alternative to stopping the delivery of new performance interventions when, at approximately hour six, monitored state 740 increases above the state level setting 480, the intervention manager 460 can opt to continue delivering time-sensitive performance interventions. For example, a critical performance intervention may need to be delivered before hour eleven. Although actual state 740 is unacceptable at hour seven, the forecast 730 indicates that state 740 will become progressively worse between hour seven and hour eleven. The Intervention Manger 460 can recognize that the conditions for delivery of the time-sensitive performance intervention are better at hour seven than any other time before hour eleven. In response, the intervention manager 460 can act to serve the contact center's operational effectiveness by rapidly delivering the time-sensitive performance interventions at hour seven.

FIGS. 7A and 7B illustrate the capabilities of the present invention to optimize resource utilization in the contact center 400 based on the forecasted availability of such resources. The depiction of state 432 in these figures as average wait time 432 is exemplary. In alternate embodiments of the present invention, the state forecast 432 and the state level 480 are direct measurements of call volume or any other form of call center state 432.

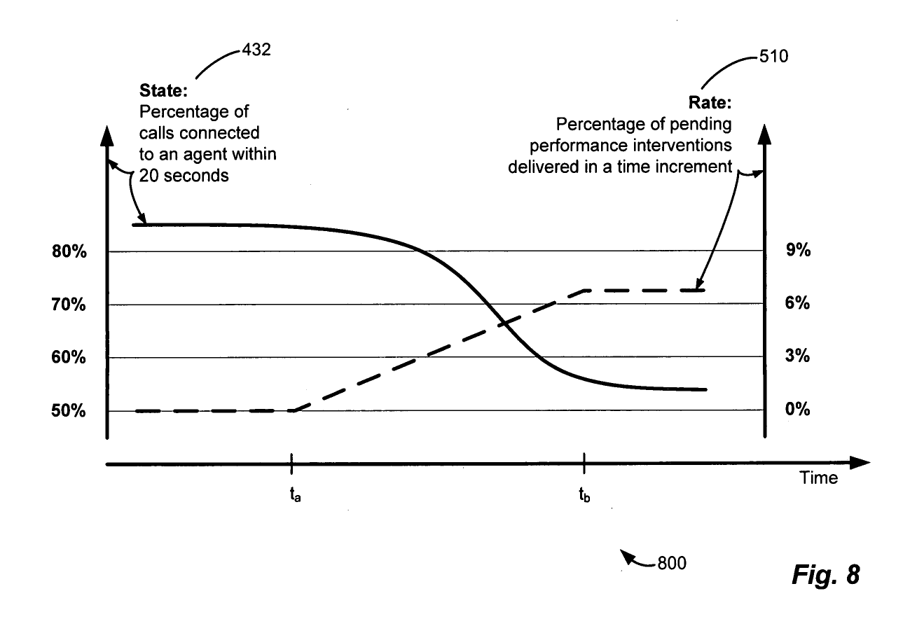

FIG. 8 is another graphical illustration of an exemplary embodiment of the intervention manager 460 responding to fluctuating conditions in a contact center 400. The graph 800 presents call center state 432 and rate 510 on a common timeline. In the embodiment supported by the illustrated functionality, state 432 is the percentage of calls connected to an agent 40 within the exemplary time of twenty seconds. Rate 510 is the percentage of pending performance interventions that are delivered in a time increment, such as an hour. In other words, rate 510 is the percentage of interventions that are delivered out of the total interventions that are eligible for delivery and for which delivery is sought.

Before time tₐ, over 80% of the calls connect to an agent 40 within twenty seconds, and the intervention manager 460 is not delivering any interventions. At time tₐ, the intervention manager 460 begins delivering interventions. Between time tₐ and time t_{b}, the intervention manager 460 increases the rate 510 of intervention delivery from zero to seven percent. In response, the percentage of calls connected within twenty seconds falls to approximately 55%. At time t_{b}, the intervention manager 460 stops increasing the rate 510 of intervention delivery and holds it constant at seven percent for some period of time. Responsive to this steady seven-percent rate, the state 432 of the contact center 400 stabilizes to approximately 55%.

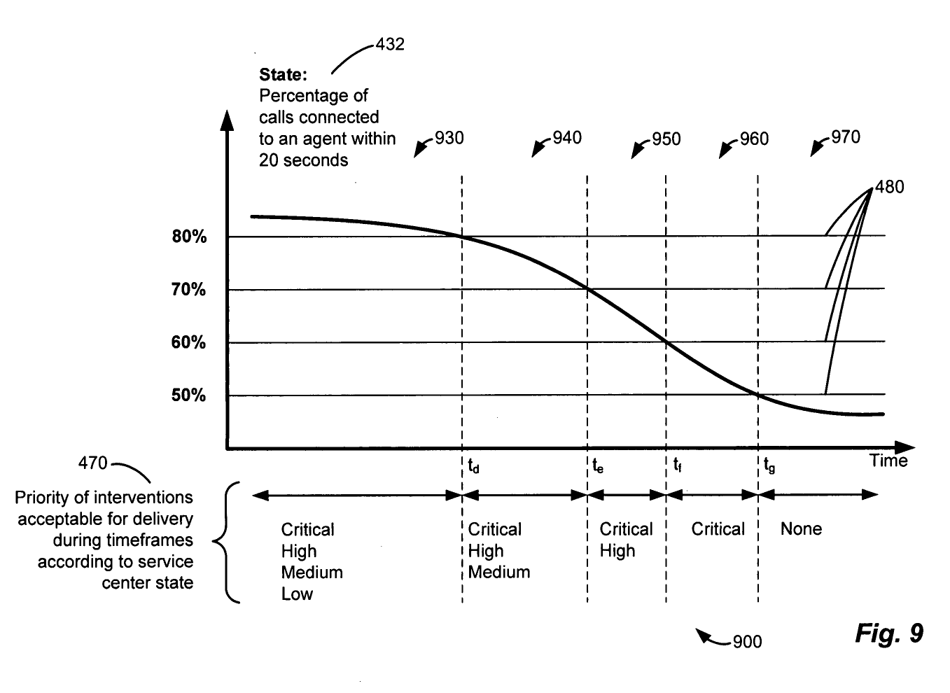

FIG. 9 graphically illustrates the functionality of the intervention manager 460 in selecting interventions based on the state 432 of the contact center 400 in accordance with an exemplary embodiment of the present invention. The illustrated graph 900 presents the percentage of calls connected to an agent 40 within twenty seconds, along an x-axis timeline. This measurement of state 432 can be a monitored value or a forecast. In the plotted time, state 432 transitions from approximately 83% to approximately 47%.

Based on management input 480, the intervention manager 460 maintains a table, a lookup table, or some data file or record that correlates acceptable intervention parameters 470 to state levels 480 defined by management input 480. The figure depicts intervention priority as an exemplary intervention parameter 470.

According to the table, the condition of 80% or more calls connected within twenty seconds, which is an exemplary time, satisfies the state-level criterion for delivering interventions having critical, high, medium, or low prioritization. For the time period 930 below time t_{d}, state 432 satisfies this criterion, and the intervention manager 460 may select a performance intervention for delivery from any of these prioritization levels if the intervention is assigned to at least one agent 40.

State 432 between 70% and 80% is the criterion for delivering critical-, high-, and medium-priority interventions. The state during time period 940 between time t_{d} and time tₑ satisfies this criterion. State 432 between 60% and 70% is the criterion for delivering critical-, and high-priority interventions. The contact center 400 meets this criterion between time tₑ and t_{f}, and the intervention manager 460 may elect to deliver interventions from either prioritization category during this time period 950. The table restricts the intervention manager 460 to delivering only critical interventions when state 432 is between 50% and 60%, as exhibited for the time period 960 between time t_{f} and time t_{g}. When state 432 falls below 50%, as it does after time t_{g}, the intervention manager 460 refrains from delivering interventions.

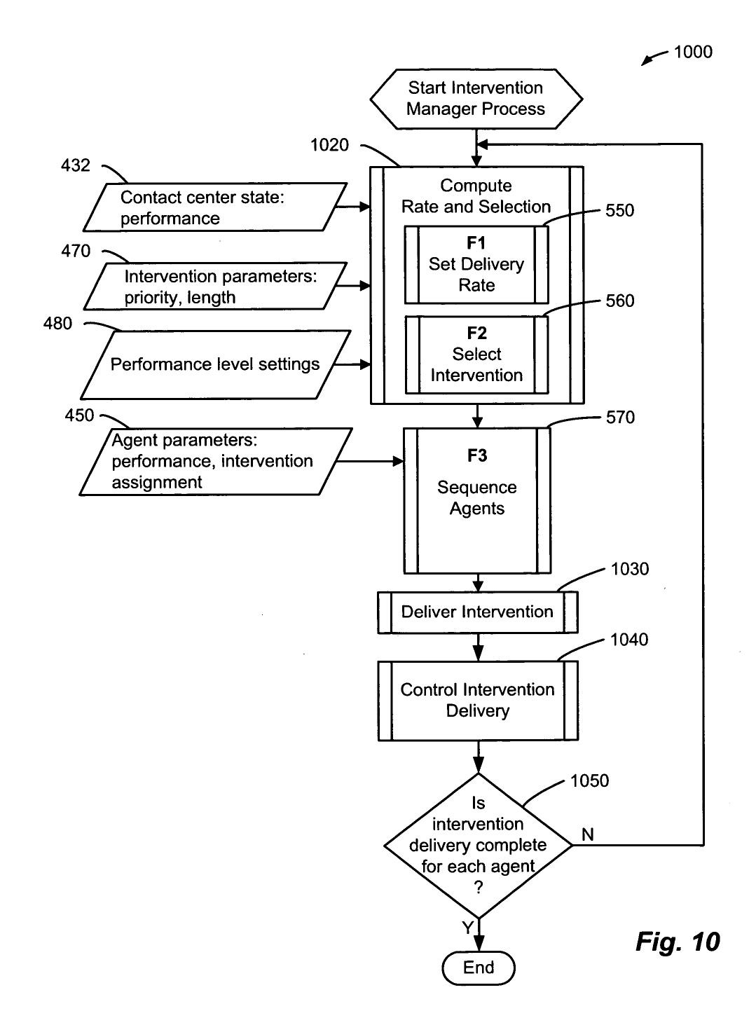

FIG. 10 illustrates an exemplary process for implementing the intervention manager 460 in accordance with an exemplary embodiment of the present invention. Process 1000, titled Intervention Manager Process, computes intervention delivery rate 510, intervention selection 520, and agent selection 530 as a function of contact center state 432, intervention parameters 470, agent parameters 450, and management input 480. Process 1000 incorporates Function F1 550, Function F2 560, and Function F3 570, which are described above, to perform the computations. The intervention manager 460 provides the results of its computations to the intervention delivery system 430, which delivers interventions following these results.

The first step 1020 of the Intervention Manager Process 1000 is a process 1020, titled Compute Rate and Selection, that includes Function F1 550 and Function F2 560, which are processes illustrated in subsequent figures. Compute Rate and Selection 1020 receives contact center state 432, intervention parameters 470, and performance level settings 480 via the contact center network 54 and uses these inputs 432, 470, 480 to compute the rate 510 of intervention delivery and the selection 520 of interventions. Function F1 550 is a process, titled Set Delivery Rate, that computes the rate 550 of intervention delivery using the inputs 432, 470, 480. Function 2 560 is another process, titled Select Intervention, that computes the selection of interventions using the inputs 432, 470, 480.

The next step of Process 1000 is a process 570 titled Sequence Agents that selects 530 agents 40 to receive performance interventions. The Sequence Agents process 570 computes the selection using agent performance and intervention assignment, which are agent parameters 450, that are typically stored in the agent profiles database 449. The selection computation illustrated in FIG. 10 is an exemplary implementation of Function F3 570 illustrated in FIGS. 5A, B, and C and described above.

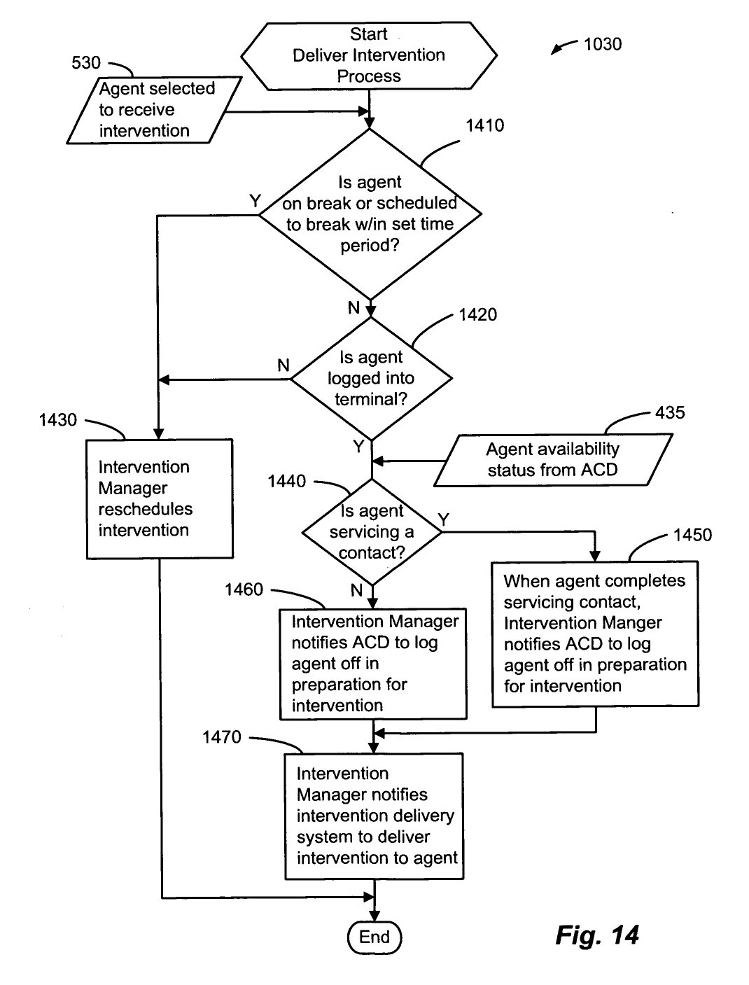

At Step 1030 of Process 1000, the intervention manager 460 interacts with the intervention delivery system 430 to deliver interventions to the agents 40 selected in Sequence Agents 570. Deliver Intervention Process 1030, which is illustrated in subsequent FIG. 14, includes functionality that communicates the status of the contact center's agents 40 to other personnel and systems in the contact center 400. Such communication supports coordinating processes in the contact center 400 to enhance operational efficiency of the center 400.

Following Step 1030, Process 1000 calls Control Intervention Delivery 1040, which facilitates the intervention manager 460 interacting with the intervention delivery system while intervention delivery is underway. Through Process 1040, the intervention manager 460 can elect to terminate intervention delivery if dynamic conditions in the contact center 400 warrant such termination. For example, if contact center performance 432 dips to an unacceptable level, Process 1040 terminates intervention delivery so that additional agents 40 can service contacts and improve performance 432.

At decision Step 1050, the Intervention Manager Process 100 iterates the previous steps in the process flow for each agent 40 of the contact center 400 for whom intervention delivery is applicable. That is, Process 1000 continuously repeats unless all pending interventions have been delivered to all eligible agents 40.

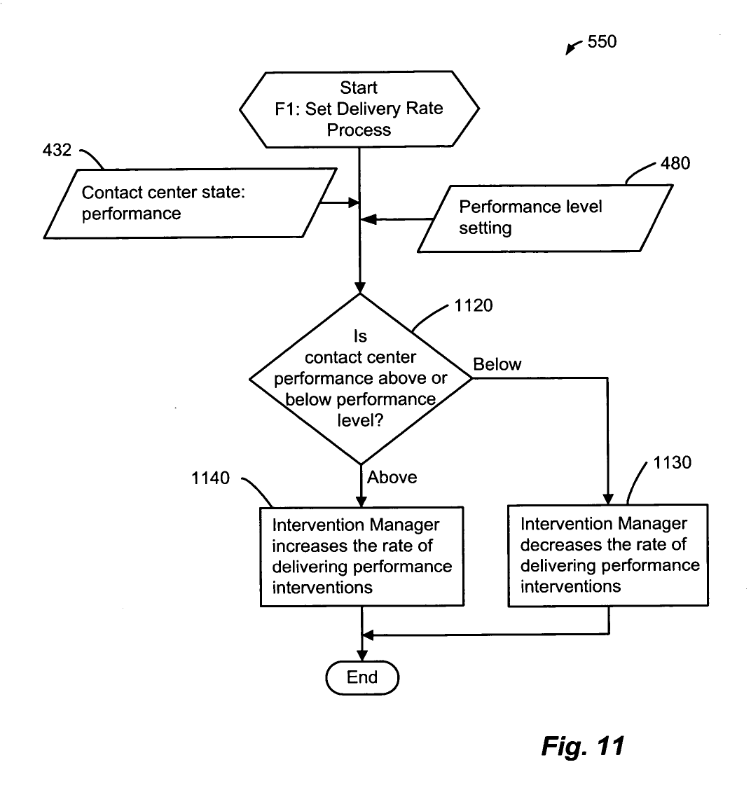

FIG. 11 is a flowchart 550 illustrating the flow and steps of an exemplary embodiment of the Set Delivery Rate Process 550 presented in FIG. 10. The Intervention Manager Process 1000 calls Process 550 as part of its Compute Rate and Selection process 1020. Process 550, as illustrated is FIG. 11, is also an embodiment of the F1 Function 550 depicted in FIG. 5B.

Exemplary process 550 begins with receiving contact center state 432 in the form of contact center performance 432 and management input 480 in the form of a state level setting 480. In the exemplary process 550, the state level setting 480 is a performance level setting 480. In other exemplary embodiments of the present invention, Set Delivery Rate Process 550 could use any of the forms of contact center state 432 and state level settings 480 discussed herein.

At inquiry Step 1120, Process 550 determines if contact center performance 432 is above or below the performance level setting 480. That is, the intervention manager 460 determines if the performance 432 of the contact center 400 is suitable to deliver performance interventions at a certain rate 510.

If performance 432 is above the state level setting 480, then at Step 1140, the intervention manager 460 instructs the intervention delivery system 430 to increase the rate 510 of delivering performance interventions. If performance 432 is below the state level setting 480, then at Step 1130, the intervention manager 460 notifies the intervention delivery system 430 to reduce the rate 510 of delivering performance interventions.

In one embodiment of the present invention, Process 550 includes multiple performance level settings 480, each triggering a distinct rate 510. In one embodiment of the present invention, rate 510 is a function of the difference between the contact center performance 432 and a performance level setting 480. The computed rate 510 is related to the deviation between performance 432 and performance level setting 480. The process 550 computes a specific rate 510 that is proportional to the magnitude of the difference between performance 432 and performance level setting 480.

In one exemplary embodiment of the present invention, the intervention manager 460 adjusts the performance level setting 480 to meet an intervention delivery goal of the contact center's management or other decision maker. In one embodiment, the intervention manager 460 notifies management if the current rate 510 of intervention delivery is insufficient to meet a managerial goal or deadline. If current constraints preclude delivering any performance interventions, then the intervention manager 460 notifies management that the performance level setting 480 needs adjustment, for example. In one embodiment of the present invention, the intervention manager 460 can elect to automatically adjust the performance level setting 480.

In one exemplary embodiment of the present invention, the intervention manager 460 computes intervention delivery rate 510 based on one or more intervention parameters 470. FIG. 5C, which is discussed above, illustrates an embodiment in which Function F1 550 of the intervention manager 460 computes rate 510 on the basis of contact center state 432, management input 480, and intervention parameters 470.

For an exemplary embodiment as illustrated in FIG. 5C, priority of intervention delivery is an intervention parameter 470 that affects the determination of delivery rate 510. The intervention manager 460 can take measures to expedite the delivery of critical priority interventions. For example, the intervention manager 460 can accelerate intervention delivery when the intervention profiles database 449 specifies that specific performance interventions have critical delivery requirements. Further, the intervention manager 460 can determine a preferred order or sequence for performance intervention delivery. Exemplary systems and methods for determining a preferred order, sequence, rank, or prioritization for performance intervention delivery are discussed in more detail below with reference to FIGS. 16-25.

In one embodiment of the present invention, management can enter, as management input 480, a deadline to deliver one or more specific performance interventions. The intervention manager 460 monitors progress towards meeting the deadline. If, as the deadline approaches, the intervention manager 460 determines that the existing rate 510 of intervention delivery is insufficient to meet the deadline, then the intervention manager 460 increases the rate 510 of intervention delivery.

The intervention manager 460 can also adapt or modify a performance intervention delivery sequence as a deadline, such as a marketing event, approaches. That is, in response to an approaching deadline, the intervention manager 460 can reprioritize or reorder the delivery of each performance intervention in a plurality of performance interventions. Such reprioritization can provide delivery preference to one or more selected performance interventions that management seeks to deliver in advance of a deadline or some other time constraint.

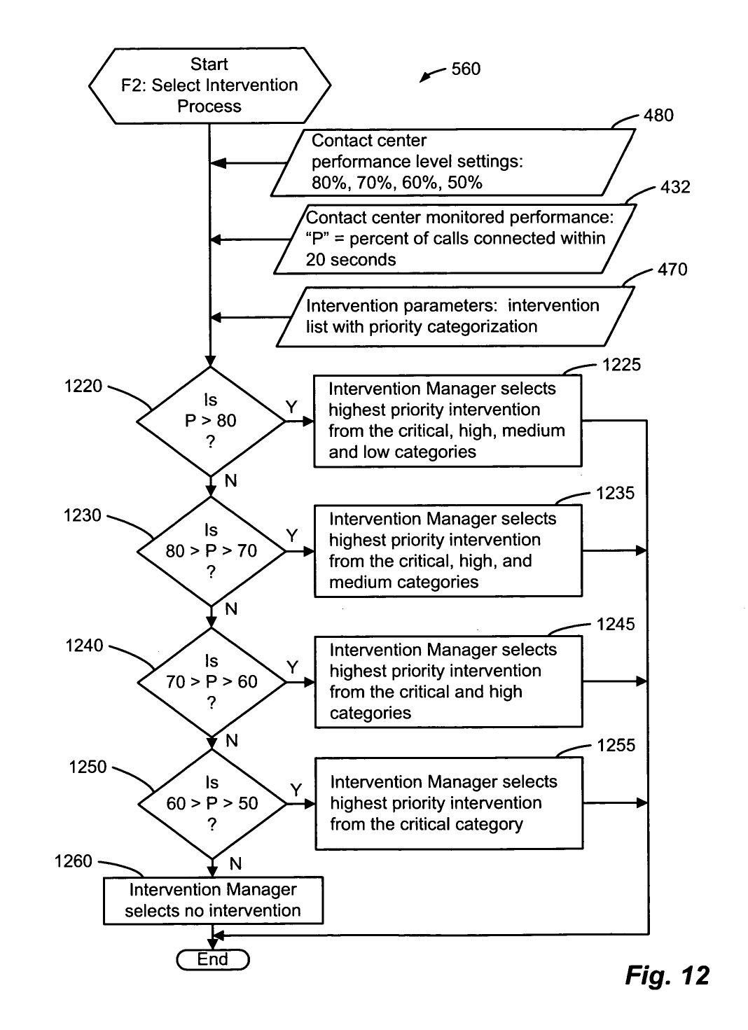

Referring now to FIG. 12, after the Intervention Manager Process 1000 determines the rate 510 of intervention delivery, it calls Select Intervention Process 560 to select one or more specific performance interventions for delivery. Process 560 is an exemplary embodiment of Function F2 560, which is depicted in FIG. 5B and FIG. 5C. The flowchart 560 includes logic and computations that implement the functionality illustrated in FIG. 9. That is, FIG. 12 illustrates exemplary processes behind the functionality depicted in FIG. 9 and is generally consistent with FIGS. 5B and 5C.

Process 560 performs the intervention selection 520 on the basis of performance level settings 480, contact center performance 432, and intervention prioritization. This data 480, 432, and 470 is available from management input 480, the ACD 32, and intervention profiles database 469 respectively.

In one exemplary embodiment, Process 560 supports establishing a preferred sequence for delivering performance interventions. That is, Process 560 can contribute to ranking performance interventions according to delivery priority by implementing one or more steps or a method for sequencing performance interventions.

At inquiry Step 1220, Process 560 determines if contact center performance 432 is above a management input performance level setting 480. More specifically, Step 1220 determines if more that 80% of the calls into the contact center 400 are connected to an agent 40 within twenty seconds, which is an exemplary time. If the determination is positive, at Step 1225 Process 560 selects a performance intervention having a critical, high, medium, or low categorization. The selection can be made by referencing conditions and/or performance intervention attributes to a lookup table. In other words, when contact center performance 432 is at its highest level, performance intervention selection 560 is not constrained to a specific intervention priority. At this performance, the intervention manager 460 can elect to deliver any performance intervention that is assigned to at least one agent 40.

At inquiry Steps 1230, 1240, and 1250, Process 560 determines if contact center performance 432 is between 80% and 70%, between 70% and 60%, or between 60% and 50% respectively. If performance 432 is less than or equal to 80% and greater than 70%, Select Intervention 560 executes Step 1235 to select a critical-, high-, or medium-category performance intervention. Performance 432 less than or equal to 70% and greater than 60% is the criterion for Process 560 to select a performance intervention from the critical and high categories of performance interventions. For performance less than or equal to 60% and greater than 50%, Step 1255 limits the intervention manager 460 to selecting performance interventions that are designated as critical. If the contact center 400 connects 50% or fewer calls to an agent 40 within twenty seconds, then, at Step 1260, Process 560 withholds selecting performance interventions for delivery until performance 432 improves.

If Process 560 determines that the performance 432 of the contact center 400 is such that multiple performance interventions meet the selection criterion and thus qualify for delivery, then the intervention manager 460 can select one or more specific interventions from the qualifying group. That is, of the performance interventions that are assigned to at least one agent 40 two or more may qualify for delivery based on the criteria of Process 560. In the case of selecting multiple performance interventions from the qualifying group, the intervention manager 460 can establish a preferred delivery sequence, via execution of Process 1700, discussed below with reference to FIG. 17, for example.

In one exemplary embodiment of the present invention, the intervention manager 460 randomly selects one of the performance interventions from the group of qualifying interventions. In another exemplary embodiment of the present invention, input from a manager of the contact center 400 narrows the choices of performance interventions. In yet another exemplary embodiment of the present invention, the performance intervention with the highest priority is selected. In yet another exemplary embodiment, the ranking engine 1600, shown in FIG. 16 and discussed below, specifies an order or sequence for delivering a plurality of selected performance interventions.

In another embodiment of the present invention, Process 560 offers an agent 40 a menu of performance interventions from which the agent 40 can select one or more specific interventions. The menu can include performance interventions having various priorities, for example several high-priority interventions and low-priority interventions. The menu can provide an indication of priority as well as any approaching deadlines for completing time-sensitive interventions. The menu can further be organized or presented to reflect a preferred or stipulated order for performance intervention receipt.

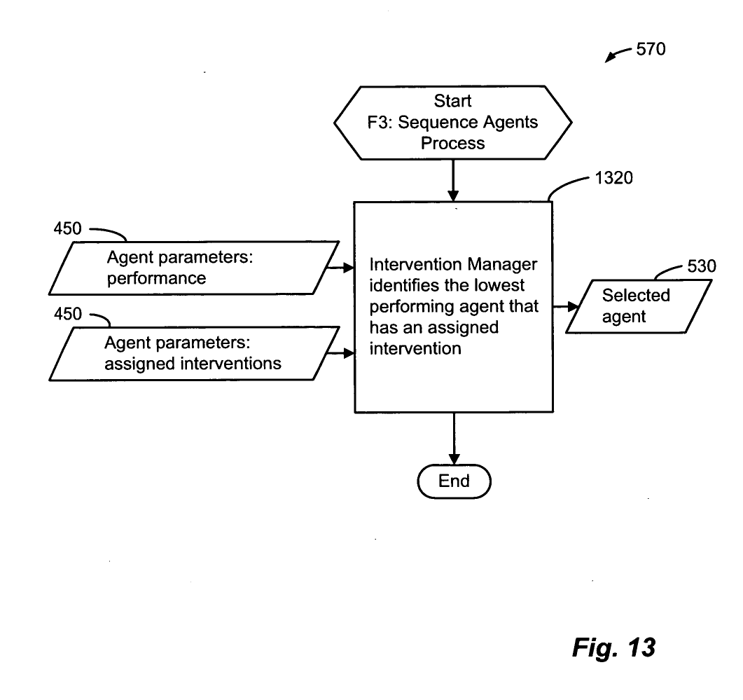

Turning now to FIG. 13, after the Intervention Manager Process 1000 determines the rate 510 of intervention delivery and the selection 520 of performance interventions, Process 570 makes a selection 530 of one or more agents 40 to receive a performance intervention. Process 570, which is titled Sequence Agents Process, is an exemplary embodiment of Function F3 570 as illustrated in FIG. 5B and FIG. 5C. The agent profiles database 449 supplies Process 570 with the performance of the agents 40 in the contact center 400 who are eligible to receive performance interventions. The database 449 also provides the process 570 with the performance interventions that are assigned to each of these agents 40.

At Step 1320, Process 570 uses agent parameters data 450 from the agent profiles database 449 to select the lowest performing agent 40 as the next agent 40 to receive a performance intervention. The intervention manager 460 notifies the agent delivery system 430 of the selected agent 530 and the performance intervention 520 selected by the Select Intervention Process 560. In compliance with these parameters 520, 530 and a delivery rate 510, the intervention delivery system 430 delivers the selected performance intervention 520 to the selected agent 530.

In one embodiment of the present invention, the agent profiles database 449 includes a ranking of the relative performance of each agent 40 who is eligible to receive an intervention. That is, the contact center 400 maintains a list of agents 40 ordered by performance, from the best performing agent 40 to the worst performing agent 40. The intervention manager 460 uses the ranked order to compose a sequence of agents 40 to receive performance interventions. The sequence starts with the lowest performing agent 40 and sequentially progresses to higher performing agents 40. In one embodiment of Process 570, Step 1320 proceeds from the lowest rank agent 40 who has an assigned performance intervention. In one embodiment of the present invention, managerial personnel in the contact center 400 can specify specific agents 40 to receive performance interventions, for example overriding a computer-generated sequence.

Those skilled in the art appreciate that the present invention supports a wide range of methodologies for identifying a single agent 40 or a sequence of agents 40 to receive a performance intervention. For example, at Step 1320 in Process 570, the intervention manager 460 can elect to select an agent 40 who is average performer, but has an assignment with a rapidly approaching deadline.

Turning now to FIG. 14, an exemplary embodiment of the Deliver Intervention Process 1030 is illustrated. Deliver Intervention Process 1030 communicates agent status information to systems in the contact center 400 to facilitate coordinated interactions between these systems and the contact center's agents 40. At the top of the flowchart 1030, the intervention manager 460 provides Process 1030 with data specifying the next agent 40 selected to receive a performance intervention.

At inquiry Step 1410, Process 1030 determines if the selected agent 40 is either on break or is scheduled to be on break within a set period of time. In one embodiment of the present invention, the set period of time is one hour. In another embodiment of the present invention, the set period of time is a multiple of the length of the performance intervention.

If the selected agent 40 is not on break, then Process 1030 executes inquiry Step 1420 to determine if the selected agent 40 is logged onto a terminal 44. Process 1030 executes Step 1430 if the selected agent 40 is on break, scheduled to be on break within a short period of time, or is not logged onto a terminal 44. In Step 1430, Process 1030 notifies the intervention manager 460 to reschedule the performance intervention based on the selected agent's lack of availability to receive the intervention.

If at inquiry Step 1420 Process 1030 determines that the selected agent 40 is free from breaks and is logged onto an agent terminal 44, then the process 1030 acquires the agent availability status 435 from the ACD 32. Using this availability status 435, inquiry Step 1440 determines if the selected agent 40 is currently servicing a contact.

If the selected agent is not servicing a contact, then at Step 1460 the intervention manager 460 notifies the ACD 32 to log the agent 40 off from servicing contacts so the agent 40 is prepared to receive the intervention. If the selected agent 40 is servicing a contact, then at Step 1450 the intervention manager 460 waits until the agent 40 completes servicing the current contact and then notifies the ACD 32 to log the agent 40 off from contact-service duties.

At Step 1470, the ACD 32 has suspended the agent's contact servicing activities and the agent 40 is prepared to receive the performance intervention. At this point, the intervention manager 460 notifies the intervention delivery system 430 to commence delivering the performance intervention to the selected agent 40. When the notification is successful, Process 1030 ends and the process of controlling intervention delivery 1040 begins.

In one embodiment of the present invention, the log-off process from the ACD 32 is a manual process. That is, rather than automatically or unilaterally logging off the agent 40 from his/her terminal 44, the process requires manual intervention by the agent 40. In this manner, the agent 40 may opt to not log off and accept a performance intervention; rather, the agent 40 may choose to continue servicing contacts or engage in another discretionary activity. Also, the agent's interaction with the ACD 32 can include the agent 40 notifying the ACD 32 of his/her availability to receive a performance intervention. That is, the agent 40 can send notification that he or she is amenable to a performance intervention at a specific time that can be defined by the Intervention Manger 460.

In one embodiment of the present invention an agent 40 can, when prompted to receive a performance intervention, delay delivery for a predetermined length of time, such as ten minutes. After the predetermined length of time has lapsed, the agent 40 can receive another request to accept a performance intervention. The agent 40 can respond by again delaying delivery. The cycle can repeat indefinitely or alternatively can terminate after a specified number of iterations.

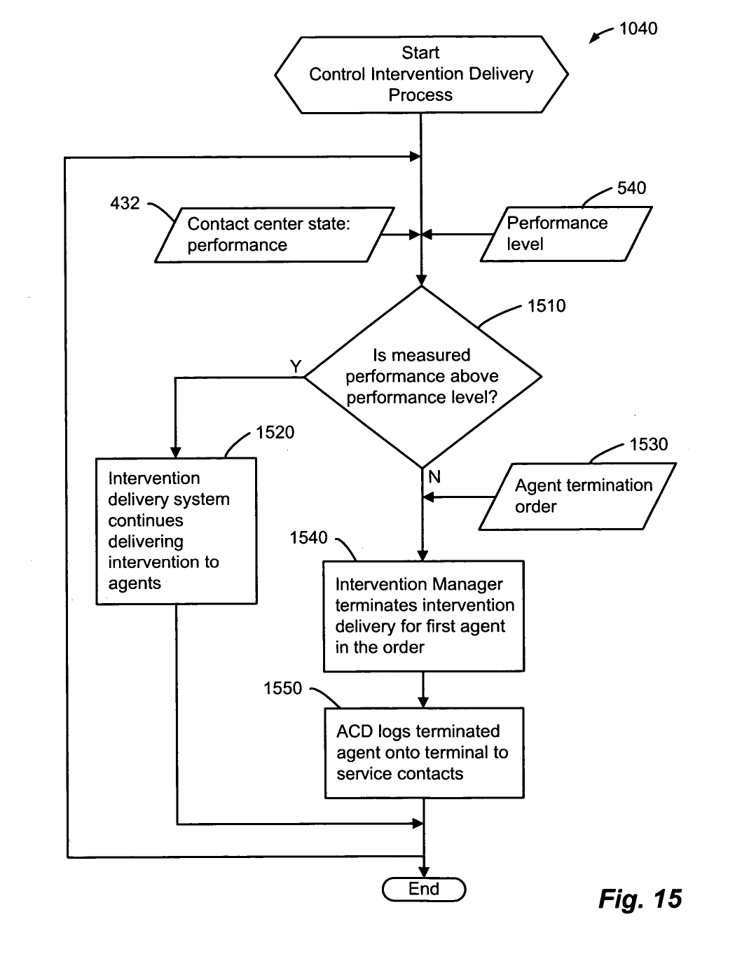

FIG. 15 is a flowchart that illustrates an exemplary embodiment of Process 1040, titled Control Intervention Delivery Process, which typically initiates after Process 1030. Monitored contact center performance 432 and management input performance level 480 are two inputs to the exemplary embodiment of Process 1040. At inquiry Step 1510, Process 1040 determines if the monitored performance 432 is above the performance level setting 480. If the performance 432 is above the performance level 480, then the contact center's operational performance is acceptable and the intervention manager 460 does not interfere with the intervention delivery system's intervention delivery.

If inquiry Step 1510 determines that monitored performance is unacceptable, then Process 1040 accesses an agent termination order 1530. In one embodiment of the present invention, the termination order 1530 is a management input 460. In another embodiment, the termination order 1530 is a random sequence. In yet another embodiment, the termination order 1530 is a derivation of the length of time since each agent 40 has received a performance intervention. For example, the agent 40 who most recently received a performance intervention is the first agent 40 in the termination order 1530, and the agent 40 who has not received a performance intervention for the longest period of time is the last agent 40 in the termination order 1530. The agent termination order 1530 can also be based on a rank of agent performance, a last-in-first-out sequence, a first-in-last-out sequence, or another methodology that serves the operational goals of the contact center 400.

At Step 1540, the intervention manager 460 instructs the intervention delivery system 430 to terminate intervention delivery for the first agent 40 on the agent termination order 1530. At Step 1550, the intervention manager 460 notifies the ACD 32 to log the terminated agent 40 on a terminal 40 to resume servicing contacts.

After executing either Step 1520 or Step 1550, Process 1040 acquires fresh monitored state data 432 and iterates the process of determining if performance is acceptable and acting on that determination.

Process 1040 supplements the functionality of the previous steps in the Intervention Manager Process 1000 by providing an increased level of responsiveness to dynamic conditions in the contact center 400. That is, in addition to establishing the parameters 510, 520, 530 of intervention delivery, the intervention manager 460 intervenes with the delivery process if conditions in the contact center 400 become unacceptable or otherwise unsuitable for delivering performance interventions.

An exemplary embodiment of an Intervention Manager Process 1000 has been described in conjunction with exemplary Functions F1, F2, and F3 550, 560, 570. Those skilled in the art recognize that the present invention supports adapting these functions 550, 560, 570, both in functionality and in sequence of implementation, to achieve a wide range of functional objectives and purposes related to managing intervention delivery in a contact center 400. For example, the intervention manager 460 can comprise a capability to compute a preferred sequence for providing contact center agents 40 with performance interventions.

An exemplary method and system for sequencing, ranking, ordering, or prioritizing performance interventions will now be discussed with reference to FIGS. 16-25 as well as various other figures discussed above. While the discussion below references “courses” in many places, those skilled in the art will appreciate that a course is but one example of a performance intervention, that reference to a course is for illustrative purposes, and that exemplary embodiments of the present invention can support a wide variety of other forms of performance interventions.

Turning now to FIG. 16, this figure is a functional block diagram representing an exemplary module 1600 that receives a list of performance interventions 1610 and ranks or sequences the performance interventions in a preferred delivery order according to an embodiment of the present invention.

In one exemplary embodiment of the present invention, the intervention manger 460 comprises one or more software programs of the ranking engine 1600. In one exemplary embodiment of the present invention, the intervention manager 460 comprises the ranking engine 1600. The ranking engine 1600 can provide an input to the intervention manager 460. Alternatively, the intervention manager 460 can provide an input to the ranking engine 1600. That is, the ranking engine 1600 and the intervention manager 460 can collaborate with one another in a variety of arrangements.

The ranking engine 1600 receives performance intervention data and uses that data to generate an ordered, sequenced, prioritized, or ranked list 1645 of performance interventions. The performance interventions can be instructional courses 1625, as illustrated in FIG. 16, that are intended to enhance agent performance at a contact center 400, for example.

Each performance intervention or course in the list of performance interventions or courses 1625 can be an output of the Function F2 560, discussed above with reference to FIGS. 10 and 12.

As shown in FIG. 16, the data input to the ranking engine 1600 comprise a list of courses 1625 arranged in a table format 1610. Exemplary embodiments of the ranking engine 1600 can receive performance intervention data organized in a variety of data formats, file structures, records, etc. The ranking engine 1600 can receive the course data as incremental or intermediate data elements, transmitted from time-to-time, or via transmission of a single data file, for example.

Each of the courses 1625, has an assignment priority 1630, represented as one of four levels, namely “critical,” “high,” “medium,” and “low.” Beyond having assignment priority 1630 represented as one of a finite number of discrete levels or values, assignment priority can be represented on a continuous or a graduated scale. The units for measuring, designating, or representing assignment priority can be arbitrary. Assignment priority 1630 can be characterized or quantified as a numerical value, such as any real number, between one and one thousand, for example.

In one exemplary embodiment, assignment priority 1630 is a characterization of the importance that a supervisor or some other authority has placed on the content of the course or some other performance intervention. Management of the contact center 400 might place a higher level of priority on a course that provides agents 40 with guidelines for legal compliance than another course that provides agents 40 with historical background about an industry, for example. Assignment priority 1630 can characterize or describe the degree of criticality of each course, for example. As another example, a contact center 400 might designate a course discussing the contact center's voluntary charitable activities as lower priority than a course teaching a sales technique deemed critical to the contact center's business mission.

As an alternative to a manual definition, assignment priority 1630 can be set or manipulated automatically, for example via a computer program. A computer program could assign an elevated assignment priority to a course that the program has identified as having a high likelihood to bolster performance of the contact center 400 or its agent staff 40.

Assignment priority 1630 characterize an attribute of a performance intervention other than content importance. For example, assignment priority 1630 can comprise a parameter or criterion that describes a probability to enhance sales, job satisfaction, employee retention, up selling, profit, contact satisfaction, contact processing speed, calls per hour, or some KPI. Thus, assignment priority 1630 can characterize a benefit that the contact center 400 is projected to obtain by investing in the delivery of the performance intervention.

In addition to the list of courses 1625 and associated assignment priorities 1630, the input data table 1610 comprises time information or temporal specifications for each course. An assignment start date specifies the date that the respective course is available to the agent 40. Typically, the agent's supervisor, or some other member of the contact center's management, specifies a timeframe or time period during which an agent 40 should receive an assigned performance intervention. The assignment start date 1635 coincides with the beginning of that timeframe, while the complete-by date 1640 specifies or designates the end of that assignment timeframe. A time period that the training system 20 makes a CBT course available for remote access can define the assignment start date and the assignment complete-by date, for example.

The complete-by date 1640 can set a deadline or a time limit for a course assignment. A manager may require that a specific set of agents 40 take a product course in advance of a product launch or a sales campaign, for example. FIG. 21, discussed below, presents an exemplary GUI window 2100 through which a manager can specify the open and close dates for each performance intervention.

Thus, an exemplary input to the ranking engine 1600 comprises a plurality of performance intervention identifiers 1625, a representation 1630 of the importance of each performance intervention, and a representation 1635, 1640 of a time criterion for delivering each performance intervention. More generally, the input to the ranking engine 1600 can comprise two or more performance intervention identifications and two or more parameters, values, or criteria that each describes, specifies, characterizes, represents, or quantifies some attribute of each performance intervention.

The first parameter may describe course importance while the second parameter may describe some temporal or time-based aspect of a course. Thus, in one exemplary embodiment, exactly one of the two parameters might relate to time. One of the two parameters could describe urgency.

Other exemplary embodiments of the input table 1610 might comprise data describing each performance intervention's value, cost, anticipated return-on-investment (“ROI”), historical results, predicted benefit, demonstrated ability to heighten performance, length, opportunity cost, etc.

One exemplary embodiment of the ranking engine 1600 accepts three or more parameters for each course 1625 or performance intervention. One such parameter might specify whether each performance intervention assignment is optional or is required.

Another parameter could describe one or more aspects of one or more agents 40 that are intended recipients, potential recipients, or past recipients of performance interventions. Such a parameter could comprise an agent's demonstrated, measured, or monitored performance. A parametric input to the ranking engine 1600 could describe each agent's knowledge, personality profile, education, propensity to be impacted by a course, traits, skills, or test results, to name a few possibilities.

In one exemplary embodiment, the table 1610 is specific to or is tailored for individual agents 40 of the contact center 400. For example, data input to the ranking engine 1600 could describe how individual agents 40 are likely to respond to specific performance interventions. Individual responses can depend upon each agent's experience, personality, seniority, or education, for example.

In one exemplary embodiment of the present invention, the ranking engine 1600 assigns a priority to, ranks, or sequences each performance intervention in a set of performance interventions based on at least two intervention parameters.

Whether the input data comprises two, three, or more parameter for each course 1625, the ranking engine 1600 applies rules, statistical methods, artificial intelligence, lookup tables, intelligent software or algorithms, learning systems or algorithms, computations and/or some other form of processing to those inputs to derive a preferred order, sequence, rank, or lineup for delivering the courses 1625 to one or more agents 40. That is, the ranking engine 1600 receives the table of course data 1610 and outputs an organized arrangement, list, or table 1645 that specifies a preferred sequence or order 1650 of performance interventions for receipt by the agents 40. The output table 1645 can specify the performance intervention delivery sequence for individual agents 40, for groups of agents 40, or for the entire agent staff 40.

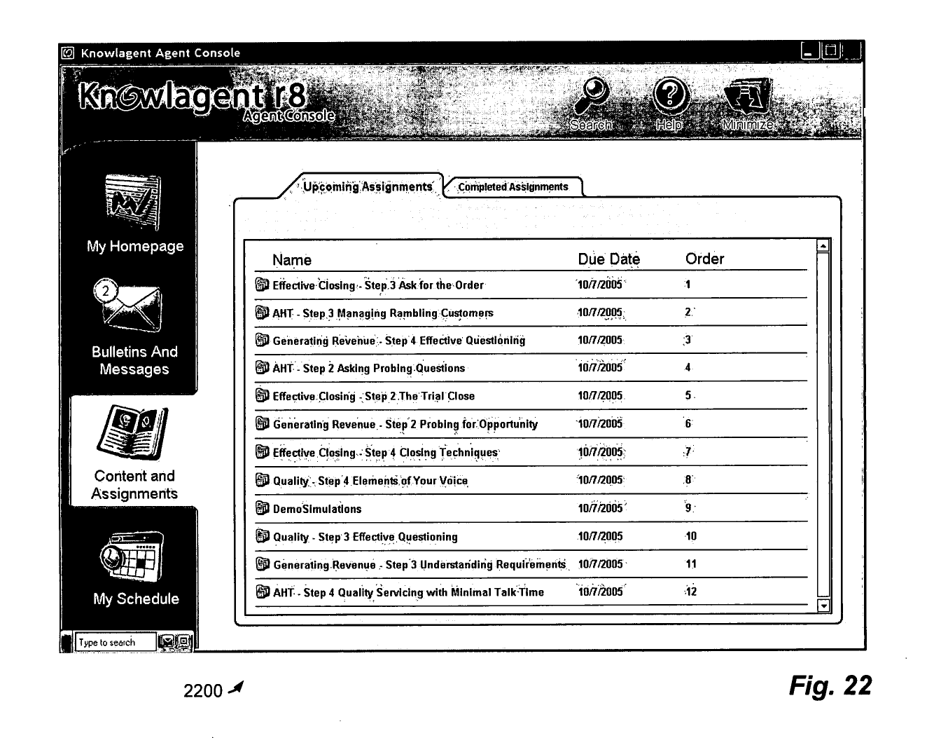

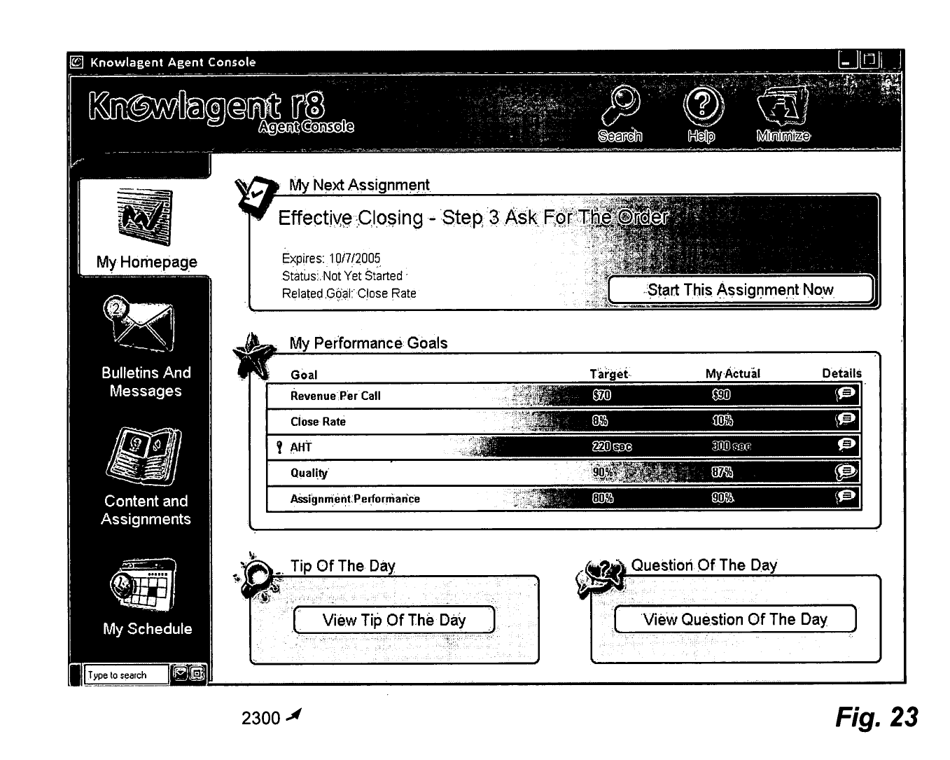

The intervention manager 460 typically receives the output table 1645 from the ranking engine 1600 and provides it to the intervention delivery system 430. The intervention delivery system 430 handles delivering the performance interventions to the respective agents 40 in accordance with the specified sequence. As discussed in more detail below with reference to the GUIs of FIGS. 22 and 23, computer monitors of the agent terminals 44 show each agent 40 his or her course lineup and related information. As an alternative to an agent 40, the intervention delivery system 430 can deliver the performance interventions to a supervisor, a member of management, a member of an accounting department, a member of a support staff, or some other member of the contact center's workforce, for example.

The ranking engine 1600 can generate the sequenced list 1645 of performance interventions via batch processing, via continuous updates, or via on-demand processing.

In one exemplary embodiment of the present invention, one or more computer-based processes or computer-based systems determines multiple aspects of the contact center's performance interventions. Thus, an integrated or coordinated approach to enhancing performance of the contact center's workforce can include specifying or determining two or more or all of: a rate of performance intervention delivery, a plurality of performance interventions for delivery; a sequence of agents to receive performance interventions; and a preferred sequence for performance intervention delivery. The integrated approach can further comprise changing one or more of those specified items in response to a change in contact center state 432.

The process or function F1 550 can determine the delivery rate. The process or function F2 560 can determine the performance intervention selections. The process or function F3 570 can determine the agent sequence. The ranking engine 1600 can determine performance intervention sequence. The intervention manager 460 can make adjustments according to contact center state 432. That is, the ranking engine 1600 can operate in coordination or collaboration with one or more of F1 550, F2, 560, and F3 570, which are discussed above with exemplary reference to FIGS. 4-15.

Turning now to FIG. 17, this figure is a flowchart of an exemplary process 1700 for initiating the ranking of performance interventions according to an embodiment of the present invention. Process 1700, which is entitled Trigger Ranking of Performance Interventions, monitors for events or conditions that trigger the ranking engine 1600 to compute, refresh, or update the sequenced list of performance interventions 1645. The ranking engine 1600 can execute or use Process 1700 as an exemplary method to generate the prioritized list 1645 of courses 1625.

Via decision Steps 1710, 1720, 1730, 1735, and 1740, Process 1700 applies a series of rules or decision criteria to operating conditions or variables of the contact center 400. When an appropriate criterion is met, Process 1700 executes Step 1750 to sequence the performance interventions for prioritized delivery. As discussed in further detail below, certain decision steps may trigger a global sequencing (or re-sequencing) of performance interventions, while other decision steps may trigger re-sequencing of the performance interventions that apply to specific agents 40.

At decision Step 1710, the ranking engine 1600 determines if a predefined time, such as the end of one day and the start of the next day, has arrived or occurred. A timekeeping program could determine whether the current time is 12:00 midnight, 2:00 a.m., or some other time that the ranking engine 1600 is configured to recognize, for example. At the designated time, the ranking engine 1600 updates the performance intervention sequence 1650 for all agents 40 of the contact center 400. Process 1700 executes Step 1750, which is entitled Rank Performance Interventions, to implement the sequencing operation when the time condition is met at Step 1710.

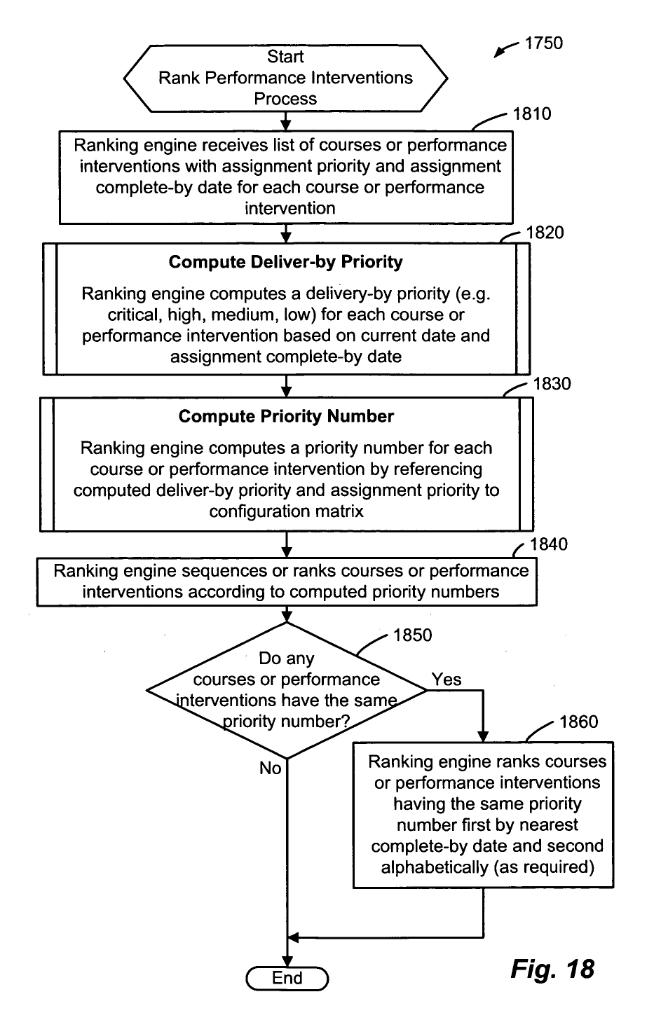

At Step 1750, the ranking engine 1600 computes the preferred order for taking the courses based on management-assigned priorities 1630, assignment complete-by dates 1640, and the current time or present calendar date. FIG. 18, discussed below, illustrates an exemplary embodiment of Step 1750 as Process 1750.

At decision Step 1720, the ranking engine 1600 determines whether an agent 40 has been assigned to a new working group or a new team of the contact center 400. A personnel change of a contact center team, such as shuffling an agent 40 from one team to another, typically calls for refreshing the course sequence 1650 since each team may have a distinct curriculum of performance interventions. Individual team supervisors may place different levels of emphasis or importance on specific performance interventions. If a working group has undergone a personnel change, then at Step 1720, Process 1700 branches to and executes Step 1750.

When executed via Step 1720, Step 1750 typically limits its re-sequencing to the performance interventions of the impacted agents 40, rather than for all of the agents 40 of the contact center 400. Focusing the sequencing operation on the relevant performance interventions and the relevant agents can conserve computing resources.

At decision Step 1730, the ranking engine 1600 determines whether any assignments have been reprioritized or added by a supervisor or a computer program, that is manually or automatically. The supervisor may elect to downgrade the priority of a specific performance intervention, for example. The supervisor may also exercise an option to override a machine-generated priority classification or even a full sequence. If a course assignment has been altered, then Process 1700 executes Step 1750 following Step 1730. Otherwise, Step 1740 follows Step 1730. When executed via Step 1730, Process 1750 typically limits its sequencing operation to the relevant courses and agents 40.

At decision Step 1735, the ranking engine 1600 determines whether any course have regrouped. Performance interventions can be organized in groups, such as in a series of related courses, to facilitate efficiently managing the training of agents. If a new course has been added to or removed from a course group, then execution of Step 1750 follows Step 1735 to update the course sequence for the relevant courses and agents.

At decision Step 1740, the ranking engine 1600 determines whether the training system 20 has changed any aspect of any of the courses. From time-to-time the training system 20 may add new content to a course or make some other change. If the ranking engine 1600 determines that a course has undergone a material change, then Process 1700 re-computes the course sequence 1650 for the relevant courses by executing Step 1750.

Beyond the illustrated decision steps 1710, 1720, 1730, 1735, 1740, the ranking engine can apply a variety of rules, trigger conditions, and/or stimuli as a basis for refreshing the course sequence. In one exemplary embodiment, the ranking engine 1600 executes Step 1750 in response to an agent 40 taking a course. In one exemplary embodiment of the present invention, the ranking engine 1600 executes Step 1750 upon the appearance of empirical data suggesting that a course has actually improved agent performance.

Process 1700 iterates decision Steps 1710, 1720, 1730, 1735, and 1740 until a trigger condition initiates execution of Step 1750. Execution of Step 1750 produces a data file or table 1545 that provides a sequenced list of courses, or some other performance intervention. Following Step 1750, Process 1700 continues iterating decision Steps 1710, 1720, 1730, 1735, and 1740 until encountering another refresh criterion.

Turning now to FIG. 18, this figure is a flowchart of an exemplary process 1750 for ranking performance interventions according to an embodiment of the present invention. As discussed above, Process 1750 is an exemplary embodiment of Step 1750 in Process 1700.

At Step 1810, the ranking engine 1600 receives data comprising a list of courses 1625 or a set of identifiers of performance interventions. Each of the courses 1625 has a accompanying assignment priority 1630 and an accompanying timeframe for course completion. The timeframe can be specified by an assignment start date 1635 and an assignment complete-by date 1640 or simply via the assignment complete-by date 1640. The received data can be organized in a format similar to the data table 1610 that FIG. 16 illustrates, for example. Thus, at least two parameters each describes some distinct attribute of each respective performance intervention having relevance to sequencing the performance interventions.

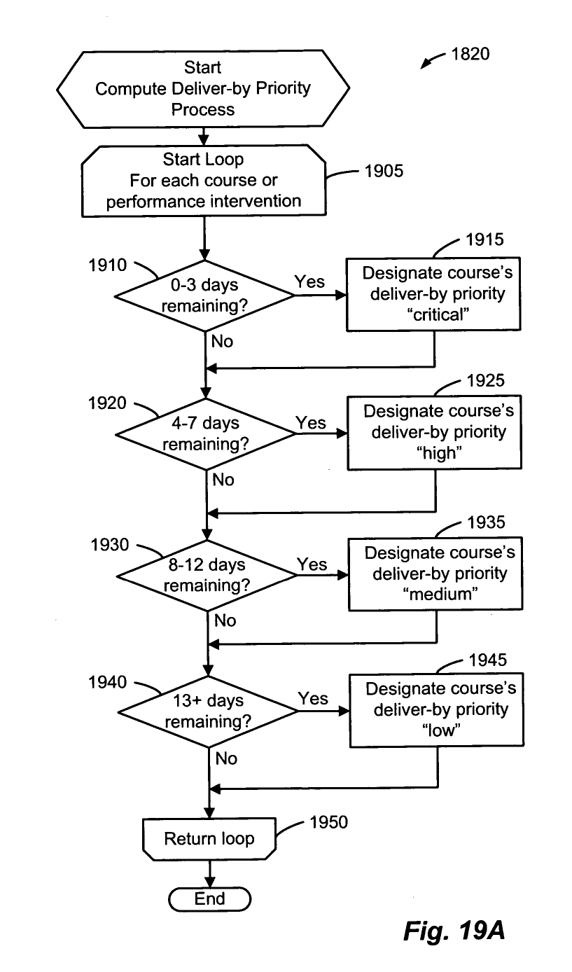

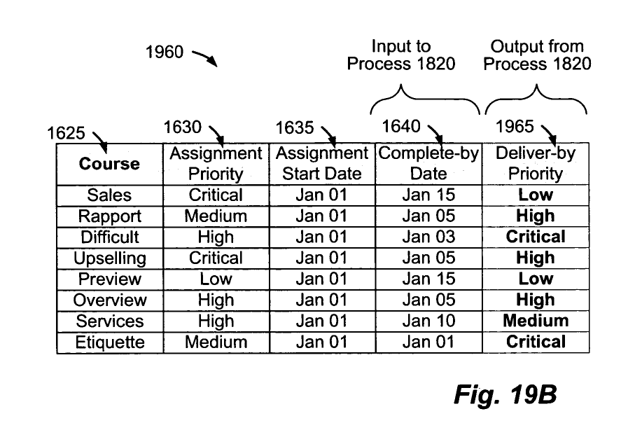

At Step 1820, which is entitled Compute Deliver-by Priority, the ranking engine 1600 computes a delivery-by priority value for each course based on the assignment complete-by date 1640 and the current calendar date. Process 1820, discussed below with reference to FIG. 19, provides an exemplary embodiment of Step 1820.

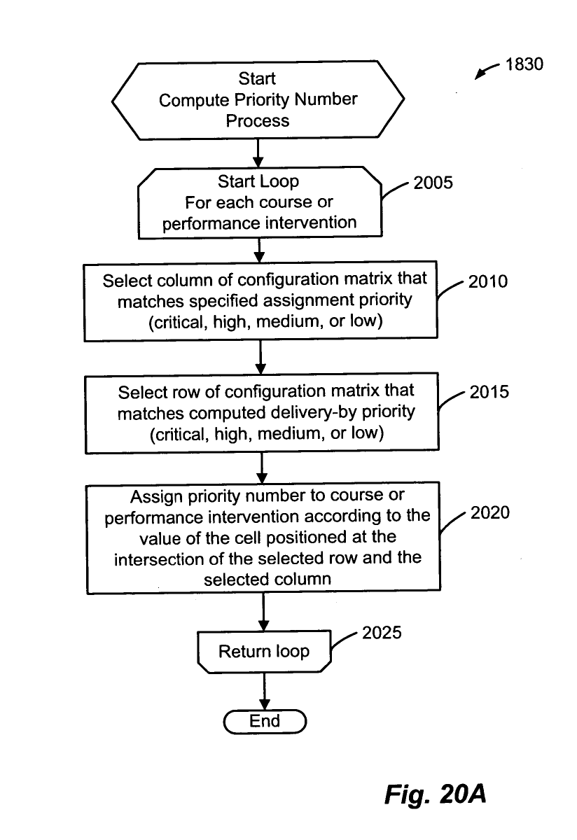

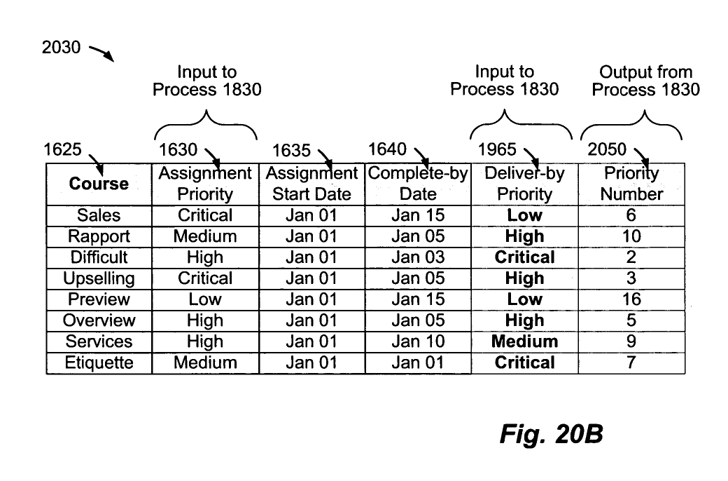

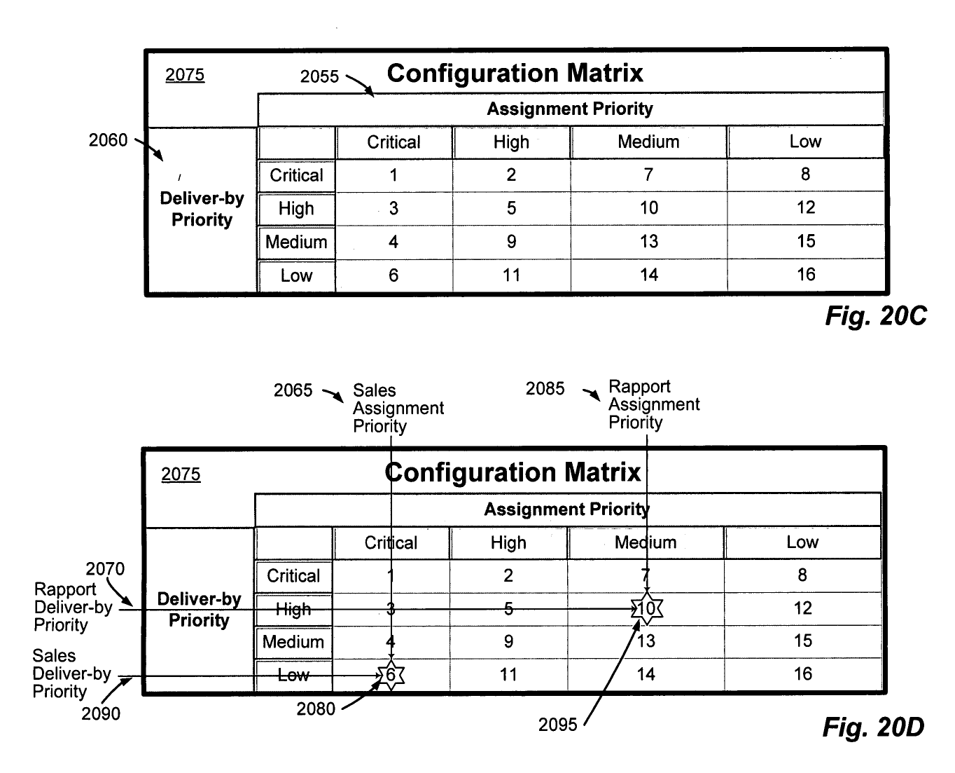

At Step 1830, which is entitled Compute Priority Number, the ranking engine 1600 generates a priority number for each course or performance intervention taking two or more factors into account. Each priority number assigns to its associated course an overall priority, urgency, or time-based importance. Thus, each course's priority number can be a value that reflects a comprehensive characterization of that course's time sensitivity. In an exemplary embodiment, the ranking engine 1600 computes the priority number for each course by referencing the course's delivery-by priority and assignment priority to a lookup table, data file, numerical matrix, configuration matrix, or table. FIG. 20, discussed below, illustrates an exemplary embodiment of Step 1830 as Process 1830.

The term “lookup table,” as used herein, refers to a set of values stored temporarily or permanently on a computer-readable medium from which a particular one of the values can be identified, obtained, selected, read, or acquired. One or more of the values can comprise a word, a number, a range of numbers, one or more characters, an alphanumerical string, a numerical identifier, an alphabetic identifier, a descriptor, a classification, a category, a series of numbers, a register, an index, or a measurement (not an exhaustive list). The computer-readable medium can comprise volatile memory, nonvolatile memory, read only memory (“ROM”), random access memory (“RAM”), a buffer, a magnetic medium such as a floppy disk, an optical storage medium, a compact disk, a sheet of paper that can be scanned or from which information can be obtained via optical character recognition (“OCR”), erasable ROM (“EPROM”), programmable read-only memory (“PROM”), or erasable PROM (“EPROM”), to name a few examples.

At Step 1840, the ranking engine 1600 sequences, orders, or ranks the courses 1625 or performance interventions based on the computed priority numbers. FIG. 16, discussed above, illustrates an exemplary table 1645 that can result from establishing a preferred course order. That is, at Step 1840, the ranking engine 1600 can output a sequenced list of performance interventions as the table 1645.

Steps 1850 and 1860 address situations in which two courses have the same priority number. At decision Step 1850, the ranking engine determines whether any of the courses have the same priority number, which was computed at Step 1830. If two or more course have the same priority number, then at Step 1860, the ranking engine 1600 sequences those courses according to nearest complete-by date. That is, the course that has the soonest complete-by date receives the highest priority. If two courses have the same priority numbers and the same complete-by date, then the courses are prioritized in alphabetical order.

Process 1750 ends following a negative determination at Step 1850 or execution of Step 1860, as applicable.

Turning now to FIGS. 19A and 19B, these figures respectively contain a flowchart and an accompanying table 1960 for an exemplary process 1820 for assigning deliver-by priorities 1965 to performance interventions according to an embodiment of the present invention. As discussed above, Process 1820, which is entitled Compute Deliver-by Priority, can be an exemplary embodiment of Step 1820 of Process 1750 and will be referred to as such.

Process 1820 executes iterates Step 1910 through Step 1945 for each course or performance intervention in the list of courses or performance interventions 1610. Step 1905 provides the loop start, and Step 1950 provides the loop return. Thus, Process 1820 sequences or cycles through each course on the course list 1625 and, applying logic or rules to time constrains associated with each course, assigns a deliver-by priority to each course.

At decision Step 1910, the ranking engine 1600 determines whether the days remaining before the complete-by date or the closing date of the course assignment in the current iteration number three or less. That is, the ranking engine 1600 compares the current calendar date to the opening and closing dates of the performance intervention assignment and determine if zero, one, two, or three days remain. If three or fewer days remain, then at Step 1915, the ranking engine 1600 designates that course as having a “critical” deliver-by priority. That is, the ranking engine 1600 assigns to the course the “critical” descriptor or parameter to indicate that the course has the highest level of urgency.

Decision Step 1920 follows a negative determination at Step 1010 or the execution of Step 1915, as applicable. At Step 1920, the ranking engine 1600 determines whether four to seven days remain for taking the performance intervention or course of the current iteration. Process 1820 executes Step 1925 if four to six days remain in advance of the closing of the course's availability, marked by the delivery-by date. At Step 1925, the ranking engine 1600 designates the course's delivery-by priority as “high.”

Decision Step 1930 follows Step 1920 or Step 1925, as appropriate. At Step 1930, the ranking engine 1600 compares the current calendar date to the assignment start date 1635 and the assignment complete-by date 1640 to determine the number of days remaining until the end of the complete-by date 1640. If eight to twelve days remain, then Process 1820 branches to Step 1935, otherwise decision Step 1940 follows Step 1930. At Step 1935, the course of the current iteration receives the “medium” designation or specification of deliver-by priority.

At decision Step 1940, the ranking engine 1600 determines whether the agent 40 has thirteen or more days before the end of the closing day of the assignment. If thirteen or more days remain before the end of the complete-by date, then Step 1945 follows Step 1940, at which the ranking engine 1600 designates the course as having “low” deliver-by priority.

Following execution of Step 1940 or Step 1945, as appropriate, loop-return Step 1950 directs the flow of Process 1820 back to Step 1905 until Process 1820 has processed each course in the course list 1625. After cycling through each course of the course list 1625, Step 1950 releases the loop iteration and Process 1820 ends.

The table 1960 that FIG. 19B illustrates presents an example of Process 1820 assigning to each course in the list of courses 1625 a deliver-by priority 1965. That is, the table 1960 could result from Process 1820 processing the table 1610 shown on FIG. 16B and discussed above. More specifically, the table 1960 illustrates assignment start dates 1635 and assignment complete-by dates 1640 that are inputs to Process 1820 along with delivery-by priorities 1965 that Process 1820 could produce or output.

Process 1820 references the current calendar date to the assignment start dates 1635 and the assignment complete-by dates 1640 to derive, compute, or output the delivery-by priorities 1965.

The example assumes that the current calendar date is January 1. That is, the delivery-by priorities 1965 result from the ranking engine 1600 executing Process 1820 on the first day of January.

At Step 1945, the ranking engine 1600 designates Sales and Preview has having a “low” level of deliver-by priority based on January 15 being more than thirteen days or more days from January 1. If the agent 40 had a two-day window for completing Sales defined by an assignment start date of January 14 and a complete-by date of January 15, then Process 1820 would still assign designate Sales as having a “low” level of deliver-by priority.

Continuing with the example table 1960, Process 1820 designates Services, which has a complete-by date of January 10, as having the “medium” level of delivery-by priority, or urgency in view of the complete-by date being between eight and twelve days from January 1.

The courses entitled Rapport, Upselling, and Overview receive the “high” designation of delivery-by priority at Step 1920 since the complete-by date of each of those course is at least four and not more than seven days from January 1.

Via Step 1910 of Process 1820, the ranking engine 1600 designates the Difficult course and the Etiquette course as each having a “critical” level of deliver-by priority because the agent 40 has three days or less are available to complete each of those courses.

Turning now to FIG. 20, this figure contains a flowchart, a data table 2030, and an operation matrix 2075 of an exemplary process 1830 for computing a priority for performance interventions according to an embodiment of the present invention. As discussed above with reference to FIG. 18, Process 1830, which is entitled Compute Priority Number, is an exemplary embodiment of a process that Process 1750 could execute as Step 1830. Thus, a software-based embodiment of Process 1750 could execute Process 1830 to implement Step 1830.

The table 2030 that FIG. 20B illustrates presents an exemplary embodiment of a data file or table comprising a course list 1625 and input and output data for Process 1830. Assignment priorities 1630 and deliver-by priorities 1965 are exemplary inputs to Process 1830. Assigned Priority numbers 2050, assigned to each performance intervention in a set of performance interventions, are exemplary outputs from Process 1830.

The matrix 2075 shown on FIG. 20B illustrates an exemplary matrix operator or a lookup table for generating priority numbers 2050 for each respective course in a list of course 1625. The table 2075 of FIG. 20B will be referred to as an exemplary embodiment of a configuration matrix that configures the priority of a performance intervention based on two distinct, but not necessarily independent, parameters that describe the performance intervention. Process 1830 can apply the configuration matrix to the assignment priorities 1630 and the deliver-by priorities 1965 to generate the priority numbers 2050.

FIG. 20D illustrates an exemplary use of the configuration matrix 2075. That is, FIG. 20D shows how Process 1830 uses the configuration matrix 2075 to generate priority numbers 2050 based on assignment priorities 1630 and deliver-by priorities 1965.

Referring now to FIG. 20A, Step 2005 and Step 2025 respectively mark the beginning and ending of a loop that Process 1830 iterates to process each course in the list of courses 1625. That is, Process 1830 executes Step 2010, Step 2015, and Step 2020 for each course.

At Step 2010 of Process 1830, the ranking engine 1600 identifies the designated or specified assignment priority for the course of the current course-processing iteration. As discussed above, in one exemplary embodiment of the present invention, assignment priority 1630 can be a parameter that characterizes at least one dimension of importance or priority that a manager or some machine or human authority has placed on a performance intervention.

The ranking engine 1600 references the course's assignment priority to the configuration matrix 2075, specifically identifying the column of the configuration matrix 2075 that matches the assignment priority of the course.

Referring briefly to FIG. 20D, for the Sales course, the ranking engine selects the “critical” column 2065 because the table 2030 of FIG. 20B indicates that the Sales course has been designated with the “critical” level of assignment priority. Similarly, the “medium” column 2085 of the configuration matrix 2075 is selected at Step 2010 for the Rapport course.

At Step 2015, the ranking engine 1600 selects the row of the configuration matrix 2075 that matches or corresponds to the deliver-by priority of the course of the current loop iteration. As discussed above with respect to FIG. 19, the ranking engine 1600 can execute Process 1820 to compute a deliver-by priority for each course. Thus at Step 2015, the ranking engine 1600 applies computed deliver-by priorities to the configuration matrix 2075.

As shown in the example of FIG. 20D, the ranking engine 1600 matches the “low” level of deliver-by priority that was computed for the Sales course to the “low” deliver-by row 2090 of the configuration matrix 2075. Similarly, the row 2070 of the configuration matrix 2075 with “high” deliver-by priority is matched to the Rapport course.

At Step 2020, the ranking engine 1600 identifies the cell of the configuration matrix 2075 that lies at the intersection of the column selected at Step 2010 and the row selected at Step 2015. That is, via Process 1830, the ranking engine selects the cell of configuration matrix 2075 defined by the deliver-by priority and the assignment priority of the course under test.

The ranking engine 1600 associates the value of the contents of the selected cell with the course. With the configuration matrix 2075 populated with numerical values as shown in FIGS. 20C and 20D, the ranking engine 1600 assigns to the course an integer between one (1) and sixteen (16), where smaller number indicate an elevated level of priority or urgency relative to larger numbers.

In other exemplary embodiments of the present invention, the configuration matrix 2075 can comprise levels, non-integer numbers, fractions, textual descriptors, measurements, or some other data, information, or items that indicate relative or absolute priority of a performance intervention.

As shown on FIG. 20D, for the Sales course, the cell 2080 is situated at the intersection of the critical column 2065 and the low deliver-by-priority column 2090. The cell 2080 contains the number “6;” thus, the Sales course is designated as having a priority number of six (6). Similarly, the ranking engine 1600 assigns to the Rapport course a priority number of ten (10) based on the contents of the cell 2095 associated with the “medium” column 2085 and the “high” row 2070.

When Process 1830 has iterated the loop between Steps 2005 and 2025, to process the data associated with each course in the list of courses 1625, the loop terminates. At that point, each of the courses has received a priority number, and Process 1830 ends.

While illustrated as in the exemplary form of a two-dimensional matrix of numbers, the configuration matrix 2075 can have three or more dimensions. Each dimension in a plurality of dimensions can correspond to a distinct parameter relevant to selecting a preferred sequence of delivering performance interventions. In exemplary embodiments of the present invention, such parameters can be independent, dependent, distinct, unique, mutually exclusive, related, or unrelated with respect to one another, for example.

A process for assigning a numerical value representing importance or priority to each course in a plurality of courses could use a three dimensional configuration matrix, with each dimension corresponding to a parameter of relevance to determining a preferred sequence for course delivery. A first dimension, for example matrix height, might have an associated parameter that describes or characterizes a time constraint for course delivery. A second dimension, for example matrix width, might have an associated parameter that describes or characterizes a content importance. A third dimension, for example matrix depth, might have an associated parameter that describes or characterizes some aspect of the agent 40, such as the agent's skills, demonstrated performance, traits, experience, aptitude, etc.

Matching course and agent parameters to the relevant height, width, and depth of a three-dimensional configuration matrix can identify a priority number or some other characterization of overall course importance, rank, urgency, sequence, or order as applicable to one or more agents. In general, a configuration matrix, a data file, a lookup table, or some other operator can have an arbitrary number of dimensions in accordance with an exemplary embodiment of the present invention.

In one exemplary embodiment of the present invention, the application of the configuration matrix 2075 to a plurality of parameters related to attributes of one or more courses and one or more agents can generate a course curriculum. Thus, an exemplary embodiment of the ranking engine 1600 can generate a preferred curriculum of performance interventions. The preferred curriculum of performance interventions can be customized, individualized, or personalized for one or more agents 40 of the contact center, for example.

In one exemplary embodiment, the configuration matrix 2075 can be viewed as parameters or variables in one or more rules that the ranking engine 1600 applies to course and/or agent data to compute or calculate a course ranking.

The configuration matrix 2075 can be generated in various ways, according to preference of a particular contact center 400 or a supervisor of a specific team of agent 40, for example. In one exemplary embodiment of the present invention, a manager, a training specialist, or some other human manually specifics the configuration matrix 2075. A supervisor may individualize the configuration matrix 2075 for specific agents 40 or may elect to configure or tailor it for application to a team of supervised agents 40.

FIGS. 21, 22, and 23 show exemplary graphical user screens or GUI windows that members of the contact center's workforce can use to access information about course and to control or configure the ranking engine 1600 and/or the ranking engine's processes.

In one exemplary embodiment of the present invention, the software application package that Knowlagent, Inc. of Alpharetta, Ga. markets under the name “Knowlagent r8 solution.” can implement or embody the functions of the ranking engine 1600. In such an embodiment, that software application package can generate screens that resemble one or more of the GUI windows 2200, 2300, 2400 respectively illustrated in FIGS. 21, 22, and 23 and discussed below.

Turning now to FIG. 21, this figure is an illustration of an exemplary GUI window 2100 for specifying rules for prioritizing performance interventions according to an embodiment of the present invention. The supervisor or a system administrator can call or access the GUI window 2100 from a supervisor station or terminal or a system workstation, for example. The GUI window 2100 comprises an area 2150 for configuring the ranking engine's function of computing deliver-by priorities 1965 to performance interventions and an area 2125 for configuring the configuration matrix 2075.

The supervisor enters numbers into the fields 2150 to specify a number of days associated with each of four levels of deliver-by priority, four being an exemplary number. Thus, as shown in FIG. 21, the supervisor can define “critical” as 0-3 days, “high” as 4-7 days, “medium” as 8-12 days, and “low” as 13 to 99 days. As discussed above with reference to FIG. 19A, Process 1820 applies those specification, or other specifications that the supervisor selects, to the input course data 1610 to assign to each course a deliver-by priority. In one exemplary embodiment, the fields 2150 are populated with default values that the supervisor has the capability to change.

The supervisor populates the configuration matrix 2075 of the GUI window 2100 with priority numbers. The configuration matrix 2075 has fields 2125 that typically contain default values. The supervisor can elect to change those values to emphasis parameters that he or she believes is important.

As shown in the window 2100 of FIG. 21, a course having a “critical” delivery-by priority and a “high” assignment priority receives a two (2) priority number 2185, thus ranking that course higher than a course having a “high” deliver-by priority and a “critical” assignment priority, which receives a three (3) priority number 2180. Thus, in this situation, deliver-by priority is weighed more heavily than assignment priority based on supervisor input. However, the supervisor has the option to swap the contents of the cells 2180, 2185 to weigh assignment priority more heavily than deliver-by priority.

The capability of changing or reconfiguring the configuration matrix 2075 supports adaptability, so the sequencing of performance interventions can respond to changes in state of the contact center 400. Thus, in one exemplary embodiment of the present invention, performance interventions can be sequenced in response to a change in contact center state 432.

Turning now to FIG. 22, this figure is an illustration of an exemplary GUI window 2200 for displaying a prioritized list of performance interventions according to an embodiment of the present invention. An agent 40 who is to be a performance intervention recipient can view the lineup or sequence of performance interventions, in this case course, via the window 2200. That is, the window 2200 appears on the agent's terminal 44 or agent console and shows the agent the courses that the agent 40 should receive in the preferred or required order along with due dates for course completion. As discussed above, the ranking engine 1600 typically defines or sets the course sequence shown on the GUI window 2200.

Turning now to FIG. 23, this figure is an illustration of an exemplary GUI window 2300 for displaying information about a performance intervention to an agent 40 of a contact center 400 according to an embodiment of the present invention. The GUI window 2300 typically appears on a computer monitor associated with the agent terminal 44.

The agent 40 can access the GUI window 2300, which can be characterized as a computer-generated screen, by selecting one of the courses shown on the GUI window 2200. As shown, the GUI window 2300 provides the agent 40 with details about the agent's next or upcoming course, which is the first course shown on the GUI window 2200 of FIG. 22.

Turning now to FIGS. 24 and 25, these figures relate to adjusting priority of a performance intervention or to changing sequence for delivering performance interventions based on feedback from monitoring agent performance. That is, in an exemplary embodiment, the ranking engine 1600 or a software program connected thereto can manipulate the assignment priorities, the deliver-by priorities, or some other parameter that impacts the course sequence output by the ranking engine 1600.

Referring now to FIG. 24, this figure is an exemplary graph 2400 comparing the monitored performances of two agents 40 of a contact center 400, resulting from delivery of a performance intervention to one of the agents 40 according to an embodiment of the present invention. The data of the illustrated graph 2400 is simulated.

In an exemplary embodiment, the agent performance evaluator 410 obtains the sales data that the traces 2420, 2430 present. As an alternative to sales data, the graph 2400 could represent another KPI of importance to the contact center 400, such as contact processing speed, upselling, closing rate, etc.

Prior to the time 2410, which is late in day three, the sales 2420, 2430 of the two agents are about $400 per hour with random fluctuations that might be typical of a real-world situation. At time 2410, the agent of the trace 2420 receives a performance intervention aimed at improving sales while the agent of the trace 2430 does not receive the performance intervention.

The trace 2420 shows that the agent who received the performance intervention achieved as significant increase in sales following the its receipt. Further, that agent's increase in sales was elevated above the sales 2430 of the agent who did not receive the performance intervention. Thus, delivery of the performance intervention could be assumed to correlate with or to cause a significant sales increase.

In an exemplary embodiment of the present invention, the ranking engine 1600 can prioritize a performance intervention that demonstrates an ability to bolster sales or a history of impacting a monitored agent performance in a desirable manner.

Referring now to FIGS. 24 and 25, FIG. 25 is a flowchart of a exemplary process 2500 for setting a priority of a performance intervention based on monitored agent performance 2420, 2430 following delivery of the performance intervention according to an embodiment of the present invention. Thus, the Process 2500, which is entitled Set Priority Based on Monitored Performance, can control or manipulate Process 1700 or a called subroutine such as Process 1750, Process 1820, or Process 1830.

At Step 2510, the training system delivers one or more performance interventions, such as courses, to a subset of the total agents 40 of the contact center 400. The agents 40 may receive the performance interventions via an execution of Process 1030, shown in FIG. 14 and discussed above, for example.

At Step 2520, the agent performance evaluator 410 monitors the performance of all of the agents 40 of the contact center 400. As an alternative to monitoring all agents 40, the agent performance evaluator 410 may monitor at least one agent 40 that received the performance intervention and at least one agent 40 that did not receive the performance intervention. Monitoring performance can comprise monitoring a KPI such as sales rate or monitoring some other measure of performance. The trace 2430 and the trace 2420 exemplify monitored performance data that the agent performance evaluator 410 could collect.

At Step 2530, the ranking engine 1600 compares the monitored performance 2420 of the agent 40 or agents 40 that received the performance intervention to the monitored performance 2430 of the agent 40 or agents 40 who were not recipients. That is, the ranking engine 1600 determines whether the agents 40 that received the performance intervention outperformed the agents 40 that did not receive the performance intervention.

At decision Step 2540, the flow of Process 2500 branches according to whether the agents 40 that received the performance intervention exhibited a high level of performance relative to the agents that did not receive the performance intervention. If a correlation exists between delivering the performance intervention and monitoring a relatively high level of performance, the Step 2250 follows Step 2540.

At Step 2540, the ranking engine 1600 increases the assignment priority of the delivered performance intervention. Increasing the assignment priority of that course helps ensure that agents 40 who have not already received the performance intervention receive it on an expedited basis. Thus, the non-recipient agents 40 can receive a course via express delivery, for example.

If the performance intervention had an assignment priority of “low,” it could receive an upgraded assignment priority of “medium,” for example. Thus, the level of assignment priority might be adjusted up one or more levels.

As an alternative to adjusting the assignment priority 1630 of a course that demonstrates a history of enhancing agent performance, the ranking engine 1600 could adjust another parameter that impact the sequence of performance intervention delivery. For example, the ranking engine 1600 could increase the deliver-by priority 1965 or the priority number 2050.

In one exemplary embodiment of the present invention, the ranking engine 1600 directly manipulates the course sequence. For example, the ranking engine 1600 could move a performance intervention demonstrating an ability to bolster agent performance to the top of the lineup, designating that course as the next course for reception. In one exemplary embodiment, the ranking engine 1600 prioritizes such courses or otherwise identifying them as urgent.

In addition to elevating the priority of performance intervention, the ranking engine 1600 can decrement the priority or importance of performance interventions that fail to positively impact agent performance. For example, if a course fails to generate a desired level of measured result, the ranking engine 1600 can demote the priority or rank of that course.

In one exemplary embodiment of the present invention, changing the priority of a performance intervention turns on whether measured performance moves past a threshold. For example, the rank of each course in a plurality of course can remain fixed unless one of the courses achieves a sustained five percent increase in sales.

In summary, the present invention supports prioritizing, raking, ordering, or sequencing performance interventions to enhance the performance of a workforce of a contact center.

From the foregoing, it will be appreciated that the preferred embodiment of the present invention overcomes the limitations of the prior art. From the description of the preferred embodiment, equivalents of the elements shown therein will suggest themselves to those skilled in the art, and ways of constructing other embodiments of the present invention will suggest themselves to practitioners of the art. Therefore, the scope of the present invention is to be limited only by the claims below.

What is claimed is:

1. A computer-based method for providing courses to an agent of a contact center, comprising the steps of:
receiving a plurality of first values, each characterizing an importance of a respective one of the courses;
receiving a plurality of second values, each characterizing a time constraint for delivering a respective one of the courses;
determining a sequence for delivering the courses in response to referencing the respective first value and the respective second value of each of the courses to a lookup table; and
providing the courses to the agent via a network of the contact center based on the determined sequence.

2. The method of claim 1, further comprising the steps of:
monitoring performance of a second agent;
determining whether the monitored performance of the second agent changed following transmission of one of the courses to the second agent; and
if the monitored performance is determined to have changed following transmission of the one course, changing the first value, the second value, or the sequence.

3. The method of claim 1, further comprising the step of displaying a list of the courses, organized in accordance with the sequence, to the agent on a computer monitor,
wherein the step of providing the courses comprises:
transmitting a selected course from the displayed list to the agent; and
updating the displayed list to indicate delivery of the transmitted course.

4. The method of claim 1, further comprising the steps of:
monitoring performance of the agent during a timeframe following providing one of the courses to the agent;
monitoring performance of a second agent, that has not received the one of the courses, during the timeframe;
comparing the monitored performances of the agent and the second agent; and
changing one of the first value, the second value, and the sequence if the comparison indicates a difference between the monitored performances of the agent and the second agent.

5. The method of claim 1, further comprising the steps of:
evaluating whether one of the provided courses has increased performance of the agent more than a threshold level; and
if the one provided course is evaluated to have increased performance of the agent more than the threshold level, elevating the one provided course in the sequence.

6. The method of claim 1, further comprising the step of computing a third value based on the second value and a current time, wherein:
referencing the respective second value to the lookup table comprises referencing the third value to the lookup table; and
determining the sequence comprises:
assigning a priority to each of the courses; and
sequencing the courses according to the assigned priorities.

7. The method of claim 1, wherein the provided courses comprise a first course, a second course, and a third course.

8. The method of claim 1, further comprising the step of updating the sequence in response to an assignment of a new course.

9. The method of claim 1, further comprising the step of updating the sequence in response to a course change.

10. A computer-based method for sequencing performance interventions for delivery to a workforce member of a contact center, comprising the steps of:
receiving a plurality of identifiers, each identifying a respective one of the performance interventions;
for each identifier in the plurality of identifiers:
receiving a specification of a timeframe for delivering the identified performance intervention; and
receiving a specification of a priority for the identified performance intervention; and
sequencing the identifiers, based on the specification of the timeframe and the specification of the priority of each identified performance intervention, to indicate a sequence for delivering the performance interventions to the workforce member.

11. The computer-based method of claim 10, further comprising the step of displaying the sequenced identifiers on a computer monitor that the workforce member uses in connection with processing a contact.

12. The computer-based method of claim 10, wherein:
the plurality of identifiers comprises at least three identifiers;
each of the performance interventions comprises instructional content; and
the method further comprises the steps of:
communicating the instructional content of each performance intervention over a computer network of the contact center according to the sequence; and
receiving the communicated instructional content of each performance intervention at an agent terminal.

13. The computer-based method of claim 10, further comprising the steps of:
monitoring performance of another workforce member of the contact center following delivery of one of the performance interventions to the another workforce member; and
if the monitored performance of the another workforce member changes following delivery of the one of the performance interventions to the another workforce member, changing the sequence.

14. The computer-based method of claim 10, further comprising the steps of:
monitoring agent performance to evaluate whether delivery of one of the performance interventions has had a positive impact on agent performance; and
if the evaluation indicates that the one performance intervention has had a positive impact on agent performance, changing the specification of the priority of the one performance intervention.

15. The computer-based method of claim 10, further comprising the steps of:
monitoring for a change in agent performance following delivery of one of the performance interventions;
if a change in agent performance is detected, changing the specification of the timeframe of the one of the performance interventions.

16. The computer-based method of claim 10, further comprising the step of updating the sequence in response to a performance intervention assignment.

17. The computer-based method of claim 10, further comprising the step of updating the sequence in response to a supervisor of the workforce member changing the specification of the priority of one of the performance interventions.

18. The computer-based method of claim 10, further comprising the step of changing the sequence in response to a change in the timeframe of one of the performance interventions.

19. The computer-based method of claim 10, wherein sequencing the identifiers comprises the steps of:
referencing the specification of the timeframe and the specification of the priority to a table; and
in response to the referencing step, determining the sequence based on information in the table.

20. The computer-based method of claim 19, wherein the table comprises a data file.

21. The computer-based method of claim 10, wherein the sequencing step comprises:
identifying an entry of a database record for each of the identifiers based on the respective specification of the timeframe and the respective specification of the priority; and
sequencing the identifiers according to the identified entries.

21. The computer-based method of claim 21, further comprising the step of:
if two of the identified entries are identical, applying a rule to establish an order between the two identifiers.

22. The computer-based method of claim 10, wherein the workforce member is a supervisor.

23. The computer-based method of claim 10, wherein sequencing the identifiers based on the specification of the timeframe and the specification of the priority comprises sequencing the identifiers based on a weighted combination of the specification of the timeframe and the specification of the priority.

24. The computer-based method of claim 10, wherein:
the workforce member is an agent;
the method further comprises the step of receiving data input by a supervisor of the agent; and
sequencing the identifiers based on the specification of the timeframe and the specification of the priority comprises sequencing the identifiers based on a weighed combination of the specification of the timeframe and the specification of the priority, wherein the received data specifies the weighted combination.

25. A computer-based method for sequencing delivery of a plurality of performance interventions to an agent of a contact center, comprising the steps of:
determining first data describing an importance of each performance intervention in the plurality of performance interventions;
determining second data describing an urgency of each performance intervention in the plurality of performance interventions; and
sequencing delivery of the plurality of performance interventions in response to processing the first data and the second data.

26. The computer-based method of claim 25, wherein:
processing the first data and the second data comprises applying a rule to the first data and the second data; and
the plurality of performance interventions comprises at least three training courses.

27. The computer-based method of claim 25, wherein the sequencing step comprises the steps of:
computing a number for each performance intervention in the plurality of performance interventions in response to processing the first data and the second data; and
sequencing delivery the plurality of performance interventions based on the computed numbers.

28. The computer based method of claim 25, wherein processing the first data and the second data comprises assigning a priority to each performance intervention in the plurality of performance interventions based on a weighted combination of the importance and the urgency.

29. The computer-based method of claim 28, wherein an entry at a supervisor station specifies relative weights of the importance and the urgency of the weighted combination.

30. The method of claim 25, wherein:
the plurality of performance interventions comprise a plurality of courses;
determining the first data comprises receiving an importance value assigned by a supervisor of the agent for each respective course in the plurality of courses;
determining the second data comprises identifying a deadline for delivering at least one course in the plurality of courses; and
processing the first data and the second data comprises referencing the importance values and the deadline to a lookup table.

31. The method of claim 25, further comprising the steps of:
selecting one of the performance interventions based on the sequence; and
transmitting content associated with the selected one performance intervention to the agent via a communication network of the contact center.

32. The method of claim 25, further comprising the steps of:
in response to monitoring performance of the agent, determining whether the agent's performance changed following delivery of one of the performance interventions to the agent; and
if a determination is made that the agent's performance changed following delivery of the one of the performance interventions to the agent, changing the delivery sequence.

33. The method of claim 25, further comprising the steps of:
evaluating whether delivery of one of the plurality of performance interventions correlates with a monitored change in agent performance; and
if the evaluation indicates that delivery of the one of the plurality of performance interventions correlates with the monitored change in agent performance, changing the sequence of delivery of the performance interventions.

34. A computer-based method for prioritizing performance interventions comprising the steps of:
receiving a list of the performance interventions;
for each listed performance intervention receiving a first parameter and a second parameter, each having relevance to prioritizing the performance interventions;
assigning a value to each of the listed performance interventions in response to processing the first and second parameters;
ranking the listed performance interventions by priority based on the assigned values;
monitoring a recipient of one of the performance interventions for a change in performance following receipt of the one of the performance interventions; and
changing the rank of the one of the performance interventions if the change in performance is monitored.
